(19) United States
(12) Patent Application Publication
(10) Pub. No.: US 2013/0249976 A1
(43) Pub. Date: Sep. 26, 2013

(54) METHOD FOR DISPLAYING IMAGE, IMAGE DISPLAY PANEL, AND IMAGE DISPLAY DEVICE

(71) Applicants: Nobuyuki Kunieda, Osaka (JP); Tatsumi Watanabe, Osaka (JP); Ken Mashitani, Osaka (JP)

(72) Inventors: Nobuyuki Kunieda, Osaka (JP); Tatsumi Watanabe, Osaka (JP); Ken Mashitani, Osaka (JP)

(21) Appl. No.: 13/883,779

(22) PCT Filed: Sep. 11, 2012
(86) PCT No.: PCT/JP2012/005741

§ 371 Date: May 7, 2013

(30) Foreign Application Priority Data
Sep. 20, 2011 (JP) 2011-205236

(51) Int. Cl. G09G 5/14

(52) U.S. Cl. CPC G09G 5/14
USPC 345/698

(57) ABSTRACT

An image display panel includes: an image display unit including pixels arranged in horizontal and vertical directions, and displaying a composite image including different images; and an image separating unit facing the image display unit, and separating the composite image into the different images using light-transmitting portions transmitting light and light-shielding portions shielding the light. Each of the pixels includes sub-pixels each including a light emitting region, the sub-pixels have sizes different from sizes obtained by equally dividing the pixel, the light-transmitting portions are open in a diagonal direction, and each of boundary lines between the light-transmitting portions and the light-shielding portions is determined by moving parallel a continuous line that connects lines each connecting gravity centers of adjacent sub-pixels or adjacent light emitting regions in the sub-pixels, or to be a continuous line that connects lines each connecting midpoints of the gravity centers.

### TECHNICAL FIELD

The present invention relates to a method for displaying a stereoscopic image to be viewed by a naked eye, an image display panel, and an image display device, and in particular to a stereoscopic image display panel using a parallax barrier method.

### BACKGROUND ART

Conventionally, image display devices that display a stereoscopic image (three-dimensional (3D) image) to be viewed by the naked eye without using special glasses are known. For example, a display such as a liquid crystal display and a plasma display panel (PDP) at an observer side is provided with a parallax barrier or a lenticular lens (spectroscopic unit). Then, a stereoscopic image is displayed by separating light from a composite image including a right-eye image and a left-eye image that are displayed on the display.

An example of a conventional method for displaying an image so that the observer can visually recognize a stereoscopic image with the naked eye will be described with reference to FIG. 15. FIG. 15 schematically illustrates an outline of the conventional method for displaying a stereoscopic image using a parallax barrier method with two views.

First, cameras 130 that are two cameras C1 and C2 capture images of a subject 300 from different viewpoints to obtain a right-eye image X1 and a left-eye image X2. Then, a format conversion unit 140 combines the two images of the right-eye image X1 and the left-eye image X2, and displays the composite image on an image display unit 110. An image separating unit 120 separates the composite image displayed on the image display unit 110 into the right-eye image X1 and the left-eye image X2, so that the observer observes the composite image as a stereoscopic image.

The image display unit 110 is, for example, a liquid crystal display or a PDP, and includes a display unit 111 in which pixels 112 are arranged in a matrix. In the display unit 111, each of the pixels 112 includes three sub-pixels (a red sub-pixel 113R, a green sub-pixel 113G, and a blue sub-pixel 113B) corresponding to red (R), green (G), and blue (B), respectively. The sub-pixels having such a structure are categorized into right-eye sub-pixels for displaying the right-eye image X1, and left-eye sub-pixels for displaying the left-eye image X2. In FIG. 15, “1” denotes the right-eye sub-pixel, and “2” denotes the left-eye sub-pixel. Furthermore, the right-eye images and the left-eye images are alternately displayed.

Furthermore, the image separating unit 120 is provided in front of the image display unit 110. In the example of FIG. 15, the image separating unit 120 includes a parallax barrier 121 in which light-transmitting portions 122 that transmit light and light shielding portions 123 that shield light are alternately formed. The light-transmitting portions 122 and the light shielding portions 123 in the parallax barrier 121 are formed so that when an observer (user) 200 in an image observation region 100 observes the image display unit 110 from a predetermined position, the observer 200 observes only the right-eye image X1 with the right eye (first viewpoint P1), and only the left-eye image X2 with the left eye (second viewpoint P2). The right-eye image X1 to be displayed in the right-eye sub-pixels and the left-eye image X2 to be displayed in the left-eye sub-pixels have a binocular parallax sufficient enough for the observer 200 to view a stereoscopic image.

With the conventional stereoscopic image display method illustrated in FIG. 15, the observer 200 in the image observation region 100 moves the head to a predetermined position (normal vision position). As a result, the right-eye image X1 enters the right eye and the left-eye image X2 enters the left eye, and thus the observer 200 can recognize the stereoscopic image (see Patent Literature (PTL) 1).

### CITATION LIST

### Patent Literature

[PTL 1] U.S. Pat. No. 7,268,943

### SUMMARY OF INVENTION

### Technical Problem

The parallax barrier 121 in the image separating unit 120 is manufactured with a shape to correspond to the image display unit 110 in which the sub-pixels corresponding to color components (red (R), green (G), and blue (B)) included in each of the pixels are uniform in shape and are uniformly formed within the pixel. Thus, when the sub-pixels corresponding to the color components (R, G, and B) included in the pixel are not uniform in shape or are not uniformly formed within the pixel in the image display unit 110, colors in the right-eye image X1 or the left-eye image X2 that are separated by the image separating unit 120 are off balance, and the image quality is degraded.

The present invention is to solve such problems, and has an object of providing a method for displaying an image, an image display panel, and an image display device for suppressing degradation in the image quality of a stereoscopic image.

### Solution to Problem

In order to solve the problems, an image display panel according to an aspect of the present invention includes: an image display unit that includes a plurality of pixels arranged in a horizontal direction and a vertical direction, and configured to display a composite image including a plurality of different images; and an image separating unit that faces the image display unit, and configured to separate the composite image displayed on the image display unit into the different images using light-transmitting portions that transmit light and light-shielding portions that shield the light, the light-transmitting portions and the light-shielding portions being alternately arranged in the horizontal direction, wherein each of the pixels includes a plurality of sub-pixels each including a light emitting region, the sub-pixels in each of the pixels have sizes different from sizes obtained by equally dividing the pixel, the light-transmitting portions are open in a diagonal direction with respect to the vertical direction, and each of boundary lines between the light-transmitting portions and the light-shielding portions is determined (i) by moving parallel a continuous line that connects lines each of which connects gravity centers of adjacent sub-pixels or adjacent light emitting regions that are included in the sub-pixels or (ii) to be a continuous line that connects lines each of which connects midpoints of the gravity centers of the adjacent sub-pixels or the adjacent light emitting regions.

### Advantageous Effects of Invention

According to the present invention, the degradation in image quality can be suppressed even when sub-pixels included in each of pixels do not have sizes obtained by equally dividing the pixel, such as a case where the sub-pixels in the pixel are not uniform in shape or are not uniformly formed.

### BRIEF DESCRIPTION OF DRAWINGS

FIG. 1 illustrates an outline of a method for displaying an image according to Embodiment 1.

FIG. 2 illustrates a configuration of an image display panel according to Embodiment 1.

FIG. 3A schematically illustrates a relationship between an image display unit and an image separating unit in the image display panel according to Embodiment 1 (view of an image at a first viewpoint P1).

FIG. 3B schematically illustrates a relationship between the image display unit and the image separating unit in the image display panel according to Embodiment 1 (view of an image at a second viewpoint P2).

FIG. 4 is an enlarged view illustrating regions of three pixels in a horizontal direction on the image display panel in FIG. 3A.

FIG. 5A schematically illustrates a relationship between an image display unit and an image separating unit in an image display panel according to Variation 1 of Embodiment 1 (view of an image at the first viewpoint P1).

FIG. 5B schematically illustrates a relationship between the image display unit and the image separating unit in the image display panel according to Variation 1 of Embodiment 1 (view of an image at the second viewpoint P2).

FIG. 6A schematically illustrates a relationship between an image display unit and an image separating unit in an image display panel according to Variation 2 of Embodiment 1 (view of an image at the first viewpoint P1).

FIG. 6B schematically illustrates a relationship between the image display unit and the image separating unit in the image display panel according to Variation 2 of Embodiment 1 (view of an image at the second viewpoint P2).

FIG. 7A schematically illustrates a relationship between an image display unit and an image separating unit in an image display panel according to Embodiment 2 (view of an image at the first viewpoint P1).

FIG. 7B schematically illustrates a relationship between the image display unit and the image separating unit in the image display panel according to Embodiment 2 (view of an image at the second viewpoint P2).

FIG. 8A schematically illustrates a relationship between an image display unit and an image separating unit in an image display panel according to Variation 1 of Embodiment 2 (view of an image at the first viewpoint P1).

FIG. 8B schematically illustrates a relationship between the image display unit and the image separating unit in the image display panel according to Variation 1 of Embodiment 2 (view of an image at the second viewpoint P2).

FIG. 9A schematically illustrates a relationship between an image display unit and an image separating unit in an image display panel according to Variation 2 of Embodiment 2 (view of an image at the first viewpoint P1).

FIG. 9B schematically illustrates a relationship between the image display unit and the image separating unit in the image display panel according to Variation 2 of Embodiment 2 (view of an image at the second viewpoint P2).

FIG. 10 illustrates an outline configuration of an image display device according to Embodiment 3.

FIG. 11A schematically illustrates a relationship between an image display unit and an image separating unit in a first conventional image display panel (view of an image at the first viewpoint P1).

FIG. 11B schematically illustrates a relationship between an image display unit and an image separating unit in an image display panel according to Variation 1 of the present invention (view of an image at the first viewpoint P1).

FIG. 12A schematically illustrates a relationship between an image display unit and an image separating unit in a second conventional image display panel (view of an image at the first viewpoint P1).

FIG. 12B schematically illustrates a relationship between an image display unit and an image separating unit in an image display panel according to Variation 2 of the present invention (view of an image at the first viewpoint P1).

FIG. 13 schematically illustrates a relationship between an image display unit and an image separating unit in an image display panel according to Variation 3 of the present invention (view of an image at the first viewpoint P1).

FIG. 14 schematically illustrates a relationship between an image display unit and an image separating unit in an image display panel according to Variation 4 of the present invention (view of an image at the first viewpoint P1).

FIG. 15 schematically illustrates an outline of a conventional method for displaying a stereoscopic image.

FIG. 16A schematically illustrates a relationship between a display unit in an image display unit in which a busbar is formed and a parallax barrier in a conventional image separating unit, as an example in which sub-pixels in each pixel do not have sizes obtained by equally dividing the pixel (view of an image at the first viewpoint P1).

FIG. 16B schematically illustrates a relationship between a display unit in an image display unit in which a busbar is formed and a parallax barrier in a conventional image separating unit, as an example in which sub-pixels in each pixel do not have sizes obtained by equally dividing the pixel (view of an image at the second viewpoint P2).

FIG. 17 is an enlarged view illustrating regions of three pixels in a horizontal direction on the image display panel in FIG. 16A.

FIG. 18 schematically illustrates a relationship between a display unit in an image display unit including sub-pixels having different sizes in each pixel and a parallax barrier in a conventional image separating unit, as an example in which sub-pixels in each pixel do not have sizes obtained by equally dividing the pixel.

### DESCRIPTION OF EMBODIMENTS

(Details on how to Arrive at an Aspect of the Present Invention)

Before starting Embodiments of the present invention, details on how to arrive at an aspect of the present invention will be described.

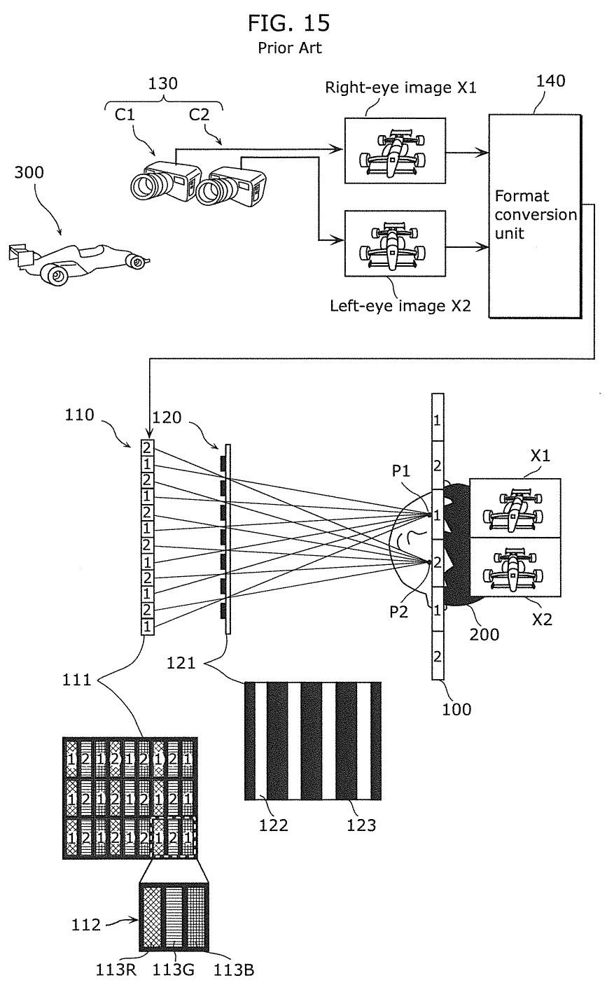

As illustrated in FIG. 15, out of the right-eye image X1 and the left-eye image X2 corresponding to two viewpoints, that is, a first viewpoint P1 (right eye) and a second viewpoint P2 (left eye), respectively, the observer 200 views the right-eye image X1 corresponding to the first viewpoint P1 with the right eye, and the left-eye image X2 corresponding to the second viewpoint P2 with the left eye. Thus, the observer 200 can stereoscopically view the subject 300.

Here, in the pixel structure of the display unit 111 of the image display unit 110, the pixel 112 includes the three sub-pixels (red sub-pixel 113R, green sub-pixel 113G, and blue sub-pixel 113B) corresponding to three colors of red (R), green (G), and blue (B), respectively. Furthermore, the sub-pixels have the same shape and the same size obtained by equally dividing one pixel.

Here, there are cases where a parallax barrier of an image separating unit has consecutive light-transmitting portions in a direction at a predetermined angle with respect to a vertical direction, and the light-transmitting portions are at predetermined intervals in a horizontal direction, which differs from the structure of the parallax barrier 121 of the image separating unit 120 in FIG. 15. In other words, there are cases where a parallax barrier having light-transmitting portions (and light shielding portions) with a diagonal shape (slant type) is used. This is because the image separating unit 120 to be used for a 3D display device with a naked-eye 3D mode (two parallaxes) often separates, in the horizontal direction, sub-pixels in the image display unit 110 into left-eye sub-pixels and right-eye sub-pixels to be alternately arranged, and does the same in the vertical direction so that the left-eye sub-pixels and the right-eye sub-pixels are alternately arranged, in consideration of the balance of resolution between the horizontal and vertical directions. Here, the intervals of the light-transmitting portions (and light shielding portions) in the slanted parallax barrier are equal to the size of each of the sub-pixels in the horizontal direction. Furthermore, the slope of the diagonal of the light-transmitting portions (and light shielding portions) is calculated based on a ratio of the size of one of the sub-pixels in the horizontal direction to the size of the sub-pixel in the vertical direction. For example, the slope of the diagonal is 3.

Although in the conventional structure, shapes and positions of the R, G, and B sub-pixels included in each of the pixels are often uniform as illustrated in FIG. 15, there are cases where the sub-pixels included in the pixel do not have sizes obtained by equally dividing the pixel.

The Inventors have found that the image quality of a stereoscopic image is degraded when an image separating unit including the slanted parallax barrier is applied to an image display unit having a pixel structure in which the sub-pixels included in each pixel do not have sizes obtained by equally dividing the pixel.

Examples in which sub-pixels included in each pixel do not have sizes obtained by equally dividing the pixel include a case where an organic EL display device is used as the image display unit. Flat display panels such as organic electroluminescence (EL) display devices use, for example, transparent electrodes including an indium tin oxide (ITO) as electrodes (upper electrodes) closer than light-emitting layers to the observers. The transparent electrodes are used to suppress the decrease in amount of light emitted from the light-emitting layers and prevent degradation in image quality. However, the transparent electrodes including ITO are of higher resistance than that of metal wires. Thus, the voltage drop occurs, and difficulties arise in stable supply of power to an entire panel. In particular, the influence of voltage drop increases with upsizing of panels of recent years. Thus, combination use of metal electrodes (busbars) of lower resistance as auxiliary wirings allows suppression of the voltage drop and the stable supply of power to an entire display panel.

However, the busbars including a metal material of lower resistance are not transparent but have a light shielding effect. Thus, the busbars need to be formed in a region different from light emitting regions. For example, the busbars are formed in light-shielding regions (non-light emitting regions) between the light emitting regions. Furthermore, the surface area of a busbar is desirably as small as possible in a plan view so as not to degrade the image quality. However, depending on the characteristics of a display, the busbar needs to be placed to be viewed by the observer.

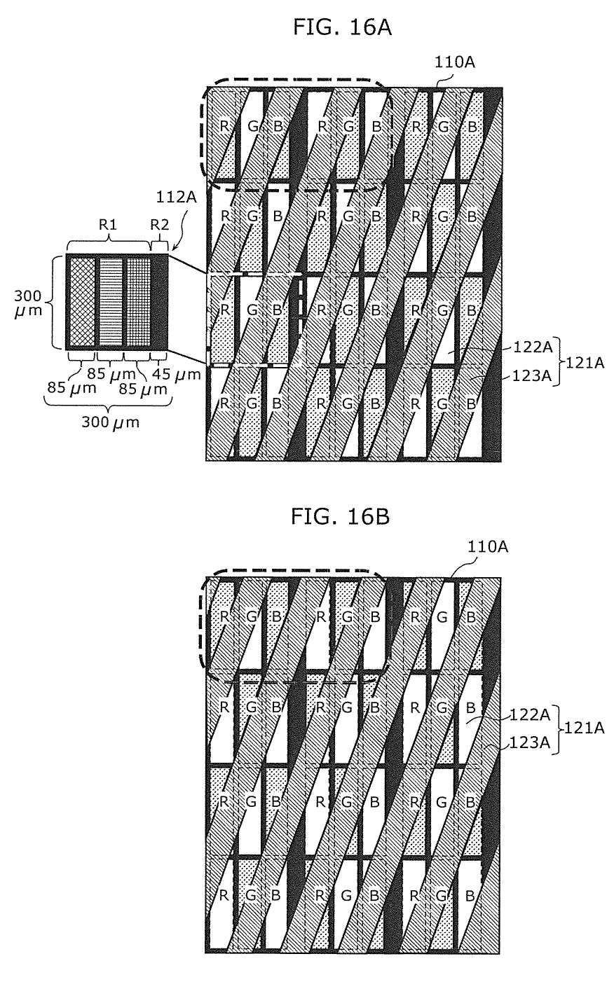

Here, a stereoscopic image display device including an image display unit in which a busbar is formed will be described with reference to FIGS. 16A and 16B. FIGS. 16A and 16B schematically illustrate a relationship in parallax barrier between a display unit in the image display unit in which a busbar is formed and a conventional image separating unit. FIG. 16A illustrates an image viewed from the first viewpoint P1, and FIG. 16B illustrates an image viewed from the second viewpoint P2.

As illustrated in FIGS. 16A and 16B, an image display unit 110A including a display unit in which a busbar is formed includes pixels 112A each of which includes a sub-pixel region R1 in which three RGB sub-pixels are formed and a busbar formation region R2 that is a light-shielding region for forming the busbar. In other words, a busbar is included in the light-shielding region between the pixels 112A that are adjacent to each other in the horizontal direction, and the intervals between the blue sub-pixels and the red sub-pixels are longer than those of the other sub-pixels. As such, in the pixel structure as illustrated in FIGS. 16A and 16B, the RGB sub-pixels are unevenly placed in the pixel 112A with the busbar. In other words, the three RGB sub-pixels do not have sizes obtained by equally dividing the pixel 112A.

Here, when an image separating unit that generates a parallax barrier 121A including slanted light-transmitting portions (light-shielding portions 123A) is applied to the image display unit 110A including the display unit in which the busbar is formed, the images viewed from the first viewpoint P1 and the second viewpoint P2 are images as illustrated in FIGS. 16A and 16B, respectively. In FIGS. 16A and 16B, the sub-pixels for displaying a right-eye image are represented by a dot pattern, and the sub-pixels for displaying a left-eye image are represented by white-on-black rectangles.

Here, the image viewed from the first viewpoint P1 is preferably an image including only the sub-pixels (dotted cells) for displaying a right-eye image. Actually, FIG. 16A illustrates that the image also includes many sub-pixels (white-on-black cells) for displaying a left-eye image in addition to the sub-pixels for displaying the right-eye image. Similarly, the image viewed from the second viewpoint P2 is preferably an image including only the sub-pixels (white-on-black cells) for displaying a left-eye image. Actually, FIG. 16B illustrates that the image also includes many sub-pixels (dotted cells) for displaying a right-eye image in addition to the sub-pixels for displaying the left-eye image. In other words, it was found that in the structure of FIGS. 16A and 16B, the image to be visually recognized as the right-eye image has a large portion of the left-eye image and conversely the image to be visually recognized as the left-eye image has a large portion of the right-eye image. For example, respective regions enclosed by dotted lines in FIGS. 16A and 16B include unnecessary images, which indicates that the image quality of a stereoscopic image is degraded.

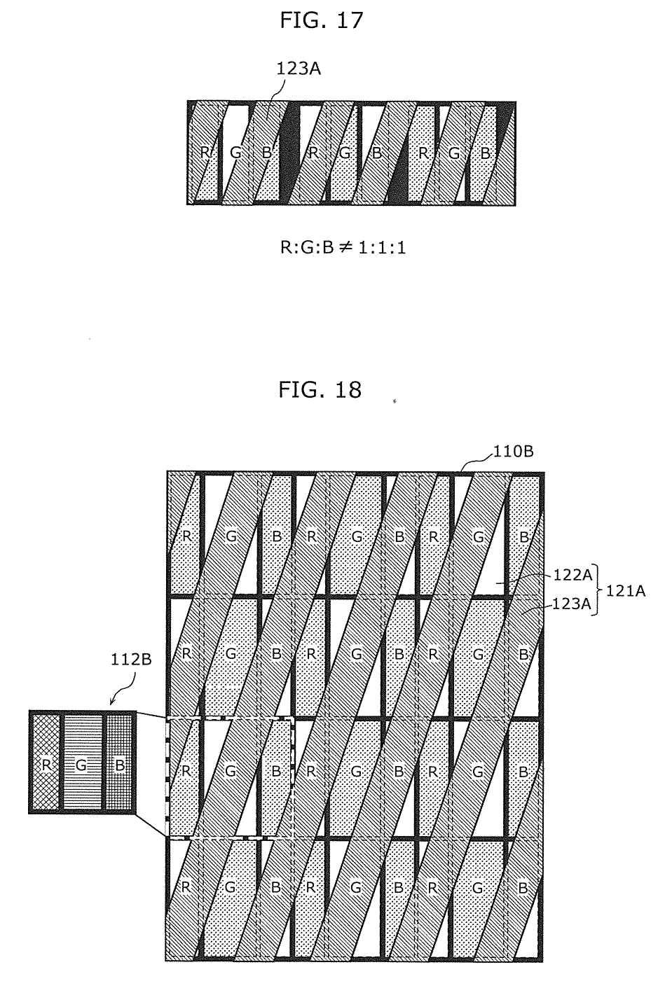

These points will be described in detail with reference to FIG. 17. FIG. 17 is an enlarged view illustrating regions of three pixels in a horizontal direction on the image display panel in FIG. 16A. It was found that the image viewed from the first viewpoint P1 includes many portions of the sub-pixels (white-on-black cells) corresponding to the left-eye image. Thus, it can be verified that an area ratio of RGB sub-pixels of the right-eye image is not 1:1:1. In other words, it is clear that colors of the sub-pixels allocated to RGB of the right-eye image viewed from the first viewpoint P1 are off balance. Thus, the black portion of the light-shielding portion 123A of the image separating unit 120A interferes with the black portion (black matrix or a light-shielding region in a non-lighting portion) of the image display unit 110A, and then color moire occurs. Thus, it is clear that even an image viewed as a right-eye image or a left-eye image has degradation in the image quality.

As such, it was found that since in the structure of FIGS. 16A and 16B, the image to be visually recognized as the right-eye image has a portion of the left-eye image and conversely the image to be visually recognized as the left-eye image has a portion of the right-eye image, the image quality of a stereoscopic image is degraded. Furthermore, it was also found that imbalance in the RGB colors causes the color moire, and the image quality is degraded with the color moire.

Furthermore, FIG. 18 illustrates another pixel structure as an example of irregular positions of sub-pixels in each pixel. Specifically, FIG. 18 schematically illustrates a relationship in parallax barrier between a display unit in the image display unit including sub-pixels having different sizes within each pixel and a conventional image separating unit. FIG. 18 illustrates an image seen from the first viewpoint P1. As illustrated in FIG. 18, each width (shape) of the RGB sub-pixels is sometimes changed to adjust luminance. Thus, the pixel structure becomes non-uniform.

Here, when an image separating unit including the parallax barrier 121A including the slanted light-transmitting portions 122A (light-shielding portions 123A) having the same structure as that in FIG. 16A is applied to the image display unit 110B including the pixels 112B each including sub-pixels having different sizes, the image viewed from the first viewpoint P1 is the image as illustrated in FIG. 18.

Here, the image viewed from the first viewpoint P1 is preferably an image including only the sub-pixels (dotted cells) for displaying a right-eye image. Actually, FIG. 18 illustrates that the image also includes many sub-pixels (white-on-black cells) for displaying a left-eye image in addition to the sub-pixels for displaying the right-eye image. Although not illustrated, the reverse is applied to the image viewed from the second viewpoint P2 as illustrated in FIG. 16B. As such, it was found that since in the pixel structure of FIG. 18, the image to be visually recognized as the right-eye image has a large portion of the left-eye image and conversely the image to be visually recognized as the left-eye image has a large portion of the right-eye image, the image quality of a stereoscopic image is degraded. Furthermore, the colors of the right-eye image and the left-eye image are off balance, the color moire occurs, and the image quality is degraded with the color moire.

As described above, the Inventors could obtain the knowledge that the image quality of a stereoscopic image is degraded due to the imbalance in colors of the right-eye image and the left-eye image and the occurrence of color moire, when a slanted parallax barrier is applied to an image display unit including sub-pixels included in each pixel and having different sizes that are not obtained by equally dividing the pixel.

Furthermore, as a result of the earnest study based on this knowledge, the Inventors could arrive at a breakthrough idea capable of suppressing the imbalance in colors, reducing the color moire, and suppressing degradation in the image quality, by designing the shape of light-transmitting portions of a parallax barrier in the image separating unit, depending on the positions of the gravity centers in each of sub-pixels.

The present invention has been conceived based on such knowledge, a method for displaying an image according to an aspect of the present invention is a method for displaying an image using (i) an image display unit that includes a plurality of pixels arranged in a horizontal direction and a vertical direction and displays a composite image including a plurality of different images and (ii) an image separating unit that faces the image display unit and separates the composite image displayed on the image display unit into the different images using light-transmitting portions that transmit light and light-shielding portions that shield the light, the light-transmitting portions and the light-shielding portions being alternately arranged in the horizontal direction, wherein each of the pixels includes a plurality of sub-pixels each including a light emitting region, the sub-pixels in each of the pixels have sizes different from sizes obtained by equally dividing the pixel, the light-transmitting portions are open in a diagonal direction with respect to the vertical direction, and each of boundary lines between the light-transmitting portions and the light-shielding portions is determined (i) by moving parallel a continuous line that connects lines each of which connects gravity centers of adjacent sub-pixels or adjacent light emitting regions that are included in the sub-pixels or (ii) to be a continuous line that connects lines each of which connects midpoints of the gravity centers of the adjacent sub-pixels or the adjacent light emitting regions.

Since it is possible to suppress mixing the different images separated by the image separating unit and occurrence of color moire caused by degradation of balance in the colors, the stereoscopic image of high quality can be displayed.

Furthermore, an image display panel according to another aspect of the present invention includes: an image display unit that includes a plurality of pixels arranged in a horizontal direction and a vertical direction, and configured to display a composite image including a plurality of different images; and an image separating unit that faces the image display unit, and configured to separate the composite image displayed on the image display unit into the different images using light-transmitting portions that transmit light and light-shielding portions that shield the light, the light-transmitting portions and the light-shielding portions being alternately arranged in the horizontal direction, wherein each of the pixels includes a plurality of sub-pixels each including a light emitting region, the sub-pixels in each of the pixels have sizes different from sizes obtained by equally dividing the pixel, the light-transmitting portions are open in a diagonal direction with respect to the vertical direction, and each of boundary lines between the light-transmitting portions and the light-shielding portions is determined (i) by moving parallel a continuous line that connects lines each of which connects gravity centers of adjacent sub-pixels or adjacent light emitting regions that are included in the sub-pixels or (ii) to be a continuous line that connects lines each of which connects midpoints of the gravity centers of the adjacent sub-pixels or the adjacent light emitting regions.

Since it is possible to suppress mixing the different images separated by the image separating unit and occurrence of color moire caused by degradation of balance in the colors, the stereoscopic image of high quality can be displayed.

Furthermore, in the image display panel according to the aspect, each of the boundary lines may be determined by moving, parallel to the vertical direction, a continuous line that connects lines each of which connects gravity centers of sub-pixels or light emitting regions that are adjacent in the diagonal direction and are included in the sub-pixels.

Furthermore, in the image display panel according to the aspect, the continuous line that connects the lines each of which connects the gravity centers of the sub-pixels or the light emitting regions that are adjacent in the diagonal direction and are included in the sub-pixels may be bent to increase an amount of light from the sub-pixels that display the different images.

Accordingly, it is possible to further suppress the degradation of balance in the colors and the occurrence of color moire.

Alternatively, in the image display panel according to the aspect, each of the boundary lines may be a continuous line that connects lines each of which connects midpoints of gravity centers of sub-pixels or light emitting regions that are adjacent in the horizontal direction and are included in the sub-pixels. Here, the lines each of which connects the midpoints of the gravity centers of the sub-pixels or the light emitting regions that are adjacent in the horizontal direction may be straight lines.

Furthermore, the lines each of which connects the midpoints of the gravity centers of the sub-pixels or the light emitting regions that are adjacent in the horizontal direction may be bent to increase an amount of light from the sub-pixels that display the different images.

Accordingly, it is possible to further suppress the degradation of balance in the colors and the occurrence of color moire.

Furthermore, in the image display panel according to the aspect, each of the pixels may include (i) a region of the sub-pixels and (ii) a region other than the region of the sub-pixels. Here, the region other than the region of the sub-pixels can be a region for forming an auxiliary wiring. Alternatively, the sub-pixels may correspond to different colors, and among the sub-pixels included in the pixel, a sub-pixel corresponding to one of the colors may be different in size from a sub-pixel corresponding to an other one of the colors.

Furthermore, in the image display panel according to the aspect, it is preferred that an area ratio of color components of sub-pixels viewed from one of the light-transmitting portions is approximately identical to an area ratio of color components of the sub-pixels included in the pixel.

Accordingly, since it is possible to improve on the imbalance in colors of the sub-pixels, occurrence of the color moire can be substantially reduced.

Furthermore, in the image display panel according to the aspect, the image separating unit may be configured to change a shape of the light-transmitting portions.

Furthermore, in the image display panel according to the aspect, the image separating unit may be configured to transmit an entirety of the composite image by disabling the light-shielding portions.

Furthermore, in the image display panel according to the aspect, the sub-pixels in the pixel may correspond to different colors.

Furthermore, in an image display device according to an aspect of the present invention, the image display panel allows a viewer to view one or both of a stereoscopic image and a two-dimensional (2D) image.

As such, the image display panel according to the aspect can be implemented as an image display device that allows a viewer to view one or both of a stereoscopic image and a 2D image.

Hereinafter, a method for displaying an image, an image display panel, and an image display device according to Embodiments will be described with reference to the drawings. Embodiments will describe favorable specific examples of the present invention. The values, shapes, materials, constituent elements, positions and connections of the constituent elements, steps (processes), and orders of the steps indicated in Embodiments are examples, and do not limit the present invention. However, the present invention is defined based on Claims. Thus, the constituent elements in Embodiments that are not described in independent Claims that describe the most generic concept of the present invention are described as arbitrary constituent elements. Each of the drawings is a schematic drawing, and is not an exact illustration.

### Embodiment 1

First, a method for displaying an image, an image display panel, and an image display device according to Embodiment 1 will be described with reference to the drawings.

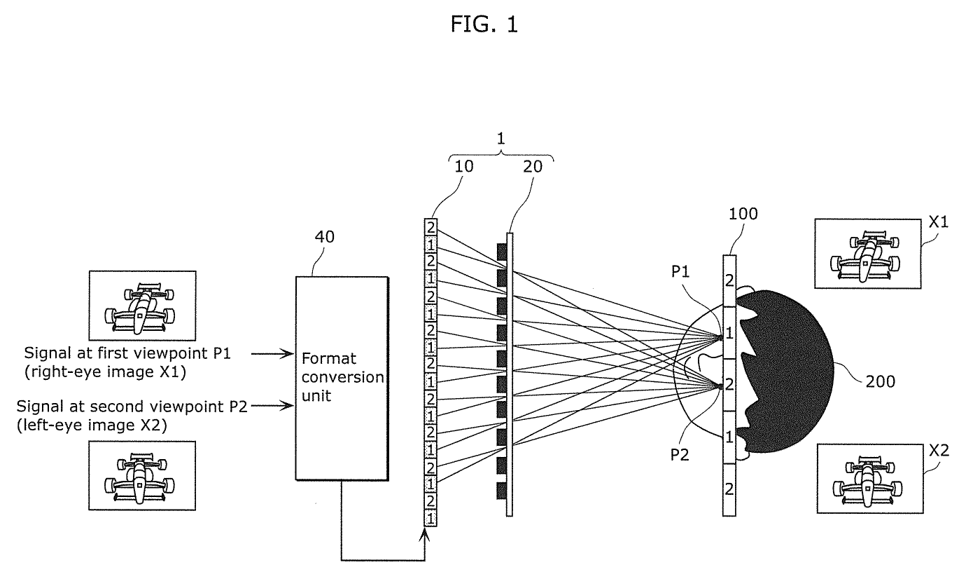

FIG. 1 illustrates an outline of a method for displaying an image according to Embodiment 1 in which an image can be stereoscopically viewed by the naked eye. Specifically, FIG. 1 illustrates a principle of two parallaxes when a stereoscopic image can be visually recognized using signals (right-eye image X1 and left-eye image X2) at two viewpoints of a first viewpoint P1 (right eye) and a second viewpoint P2 (left eye). In other words, an observer 200 in an image display region (viewing position) 100 can observe a stereoscopic image by viewing (i) the right-eye image X1 represented by the signal at the first viewpoint P1 with the right eye, and (ii) the left-eye image X2 represented by the signal at the second viewpoint P2 with the left eye, among the signals at the two viewpoints.

In the method for displaying an image in FIG. 1 according to Embodiment 1, two cameras capture images of a subject from different viewpoints to obtain the right-eye image X1 and the left-eye image X2, in the same manner as illustrated in FIG. 15. Then, a format conversion unit 40 combines the two images of the right-eye image X1 and the left-eye image X2, and displays the composite image on an image display unit (image display device) 10. An image separating unit (image separating device) 20 separates the composite image displayed on the image display unit 10 into the right-eye image X1 and the left-eye image X2, so that the observer observes the composite image as a stereoscopic image.

In FIG. 1, “1” denotes a right-eye sub-pixel, and “2” denotes a left-eye sub-pixel in the image display unit 10. Furthermore, FIG. 1 illustrates an example in which the right-eye images and the left-eye images are alternately displayed.

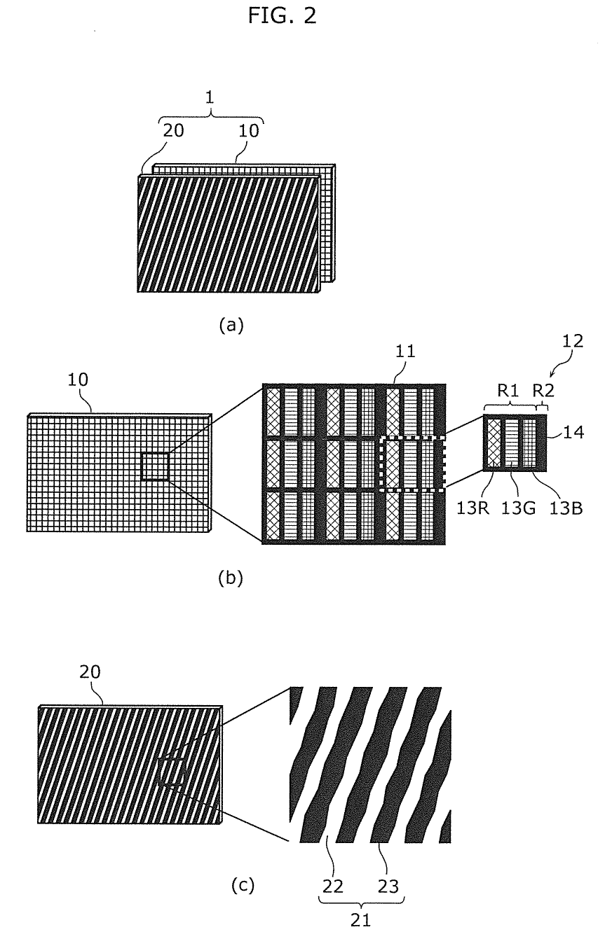

Next, an image display panel 1 according to Embodiment 1 will be described with reference to FIG. 2. FIG. 2 illustrates a configuration of the image display panel 1 according to Embodiment 1, (a) is a perspective view illustrating an outline configuration of the image display panel, (b) illustrates an outline configuration of the image display unit, and (c) illustrates an outline configuration of the image separating unit.

The image display panel 1 according to Embodiment 1 is a stereoscopic image display panel using a parallax barrier method which allows the observer (viewer) 200 to stereoscopically view the image by the naked eye. As illustrated in (a) of FIG. 2, the image display panel 1 includes the image display unit 10 and the image separating unit 20 facing the image display unit 10. According to Embodiment 1, the image separating unit 20 is at a predetermined distance from the image display unit 10, and is in front of (closer to) the image display unit 10.

Examples of the image display unit 110 includes flat panel displays, such as a liquid crystal display, a plasma display, an organic EL display, and an inorganic EL display. According to Embodiment 1, the organic EL display is used. Furthermore, examples of the image separating unit 20 include a liquid crystal shutter panel.

The organic EL display includes, for example, on a driving circuit layer (planarized layer) including a thin-film transistor formed on a glass substrate, (i) a lower electrode (anode), (ii) an upper electrode (cathode), (iii) an organic light-emitting layer (light-emitting portion) formed between the lower electrode and the upper electrode, (iv) a bank that partitions the organic light-emitting layer, (v) a sealing resin layer formed on the upper electrode, and (vi) the glass substrate formed on the sealing resin layer. Each of the lower electrode, the upper electrode, and the organic light-emitting layer is an organic EL element. Here, the upper electrode is a common electrode formed on the entirety of the sub-pixels. In contrast, the lower electrode is formed in an island shape for each of the sub-pixels.

As illustrated in (b) of FIG. 2, the image display unit 10 includes a display unit (image display surface) 11 including pixels 12 horizontally and vertically arranged in a matrix. An image obtained by combining different images is displayed on the display unit 11 as a predetermined image, such as a still image or a moving image. According to Embodiment 1, a three-dimensional (3D) image for 3D display is displayed on the display unit 11. The 3D image is a composite image of a right-eye image represented by the signal at the first viewpoint P1 and a left-eye image represented by the signal at the second viewpoint P2. Here, not only the 3D image but also a two-dimensional (2D) image are displayed on the display unit 11.

Each of the pixels (main pixels) 12 includes sub-pixels corresponding to different colors. In addition to the sub-pixels, each of the pixels 12 includes a region (busbar formation region) for forming an auxiliary wiring (busbar) as a region other than the sub-pixels. In other words, each of the pixels 12 includes a region of the sub-pixels and a busbar formation region. Thus, the sub-pixels in each of the pixels 12 do not have sizes obtained by equally dividing the pixel.

Specifically, each of the pixels 12 includes (i) a sub-pixel region R1 in which a red sub-pixel 13R having a red light emitting region that emits red light, a green sub-pixel 13G having a green light emitting region that emits green light, and a blue sub-pixel 13B having a blue light emitting region that emits blue light are formed, and (ii) a busbar formation region R2 that is a light-shielding region 14 that includes a black matrix. Each of the RGB sub-pixels has the same size (width in the horizontal direction) according to Embodiment 1. Furthermore, in the busbar formation region R2, the auxiliary wiring is electrically connected to an upper electrode (transparent electrode) for suppressing the influence of a voltage drop caused by the upper electrode.

In each of the sub-pixels, the light emitting region is enclosed by a non-light emitting region (light-shielding region) including a black matrix. In other words, the light-shielding region (non-light emitting region) including a black matrix is present between the light emitting regions that are adjacent to each other to prevent mixture of RGB colors. Furthermore, the black matrix in the busbar formation region has a width larger than that of the black matrix between the light emitting regions. The light-shielding region 14 having a larger width is formed on a per pixel unit basis. Furthermore, the red sub-pixel 13R, the green sub-pixel 13G, and the blue sub-pixel 13B are repeatedly placed in this order in the horizontal direction of the display unit 11, and the sub-pixels that emit the same color are repeatedly placed in the vertical direction of the display unit 11.

As illustrated in (c) of FIG. 2, the image separating unit 20 selectively separates a composite image displayed on the image display unit 10 so that the viewer can visually recognize at least one of the images included in the composite image. For example, when a 3D image is displayed on the display unit 11 of the image display unit 10, the image separating unit 20 generates a parallax barrier 21 for separating the 3D image into a right-eye image and a left-eye image to be stereoscopically displayed.

The parallax barrier 21 controls transmission and shielding of light to selectively transmit light, and includes light-transmitting portions 22 for transmitting light and light-shielding portions 23 for shielding light that are alternately arranged in the horizontal direction. The light-transmitting portions 22 and the light-shielding portions 23 separate the composite image displayed on the image display unit 10 into different images. According to Embodiment 1, the light-transmitting portions 22 and the light-shielding portions 23 separate the composite image displayed on the image display unit 10 into a right-eye image and a left-eye image.

Each of the light-transmitting portions 22 has a predetermined open width, and is a slit portion that are open in a direction at a certain angle with respect to the vertical direction (in the display unit 11). In other words, the light-transmitting portions 22 are successively open in a diagonal direction with respect to the vertical direction. Furthermore, each of the light-shielding portions 23 has a predetermined light-shielding width, and is a barrier portion that has a certain angle with respect to the vertical direction so as to have the same tilt angle as that of the light-transmitting portions 22. The light-transmitting portions 22 are regions between the light-shielding portions 23 that are adjacent to each other.

As such, the parallax barrier 21 according to Embodiment 1 is slanted, that is, diagonal. The light-transmitting portions 22 and the light-shielding portions 23 are diagonally striped that tilts diagonally right up (left down). The open width of the light-transmitting portions 22 (light-shielding width of the light-shielding portions 23) in the parallax barrier 21 is not constant and varies in the diagonal direction.

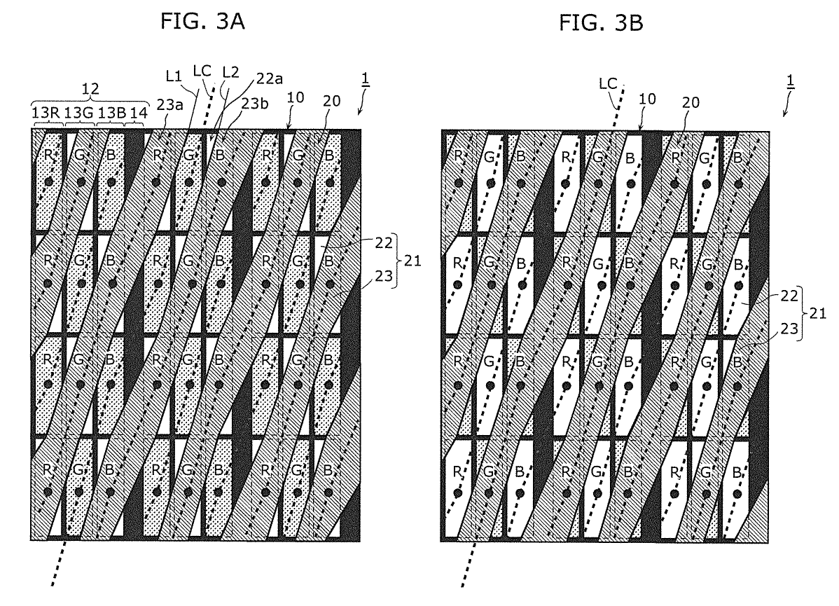

Next, the characteristic structure of the image display panel according to Embodiment 1 will be described with reference to FIGS. 3A and 3B. FIGS. 3A and 3B schematically illustrate a relationship between the image display unit and the image separating unit in the image display panel according to Embodiment 1. FIGS. 3A and 38 illustrate a state viewed from the vertical direction with respect to the image display surface. Specifically, FIG. 3A illustrates a view of an image from the first viewpoint P1, and FIG. 3B illustrates a view of an image from the second viewpoint P2. In FIGS. 3A and 3B, sub-pixels for displaying a right-eye image are represented by a dot pattern, and sub-pixels for displaying a left-eye image are represented by white-on-black rectangles. In other words, in the display unit 11, one of the right-eye image and the left-eye image is allocated per sub-pixel. In the pixels 12, the left-eye sub-pixels and right-eye sub-pixels are alternately allocated in both the horizontal and vertical directions.

As illustrated in FIGS. 3A and 3B, the shape of the light-transmitting portions 22 (or shape of the light-shielding portions 23) of the parallax barrier 21 in the image separating unit 20 is defined in accordance with a predetermined position of each of the sub-pixels in the pixels 12 of the image display unit 10. According to Embodiment 1, the shape of the light-transmitting portions 22 is designed so that the boundary lines between the light-transmitting portions 22 and the light-shielding portions 23 in the image separating unit 20 are identical to lines each obtained by moving, parallel to the vertical direction with respect to the display unit 11 (vertical direction of plane of paper), a continuous line that connects predetermined positions of sub-pixels that are diagonally adjacent to each other and are included in the sub-pixels of the entire display unit 11 (the red sub-pixels 13R, the green sub-pixels 13G, and the blue sub-pixels 13B).

Here, each of the boundary lines between the light-transmitting portions 22 and the light-shielding portions 23 corresponds to an edge shape of the light-transmitting portions 22 or the light-shielding portions 23 in the longitudinal direction. Furthermore, the predetermined positions of the sub-pixels are predetermined according to the shape of the sub-pixels, and are identical in the sub-pixels. According to Embodiment 1, the predetermined positions of the sub-pixels are gravity centers of the sub-pixels. As illustrated in FIGS. 3A and 3B, when the sub-pixels are rectangular, it may be helpful to set the predetermined positions to the gravity centers that indicate the centers of the sub-pixels.

Embodiment 1 will be described assuming that the predetermined positions are the gravity centers of the sub-pixels. In FIGS. 3A and 3B, the gravity center of each of the sub-pixels is represented by a black point (), and a continuous line that connects lines each of which connects the gravity centers of the sub-pixels that are adjacent in the diagonal direction is represented by a dashed line. According to Embodiment 1, each of the boundary lines between the light-transmitting portions 22 and the light-shielding portions 23 is determined by moving, parallel to the vertical direction, the continuous line that connects lines each of which connects the gravity centers of the sub-pixels that are adjacent in the diagonal direction. Furthermore, the boundary line is parallel to the continuous line.

A segment that connects the gravity centers of the sub-pixels that are adjacent in the diagonal direction, that is, a line from one of the gravity centers of the sub-pixels to another gravity center has a different tilt angle in the vertical direction, depending on whether or not the line is across the light-shielding region 14. This is because the segment that connects the gravity centers of the sub-pixels that are adjacent in the diagonal direction when the segment is across the light-shielding, region 14 is longer by the width of the light-shielding region 14 in the horizontal direction.

For example, in FIG. 3A, assuming focusing on an light-transmitting portion 22a, a boundary line between the light-transmitting portion 22a at one of sides (to the left) and a light-shielding portion 23a as L1 (first parallel line), a boundary line between the light-transmitting portion 22a at the other side (to the right) and a light-shielding portion 23b as L2 (second parallel line), and a continuous line that connects the gravity centers of the sub-pixels that are adjacent in the diagonal direction and correspond to the light-transmitting portion 22a by a straight line as LC, the boundary lines L1 and L2 of the light-transmitting portion 22a are determined by moving the continuous line LC that connects the gravity centers parallel to the vertical direction by Sh/2. Here, Sh denotes a length of the sub-pixel in the vertical direction. Furthermore, the other light-transmitting portions in FIG. 3A are structured similarly as the light-transmitting portion 22a. Furthermore, the light-transmitting portions 22 in FIG. 3B are structured in the same manner as the light-transmitting portions 22 in FIG. 3A.

Here, FIG. 3A shows that the image observed from the first viewpoint P1 as a right-eye image has a lower rate of unnecessary sub-pixels (white-on-black cells) for displaying a left-eye image and a higher rate of necessary sub-pixels (dotted cells) for displaying the right-eye image than those of FIG. 16A. In other words, according to Embodiment 1, it is possible to reduce a rate in which a left-eye image is mixed in the image to be visually recognized as a right-eye image. Similarly, FIG. 3B shows that the image observed from the second viewpoint P2 as a left-eye image has a lower rate of unnecessary sub-pixels (dotted cells) for displaying a right-eye image and a higher rate of necessary sub-pixels (white-on-black cells) for displaying the left-eye image than those of FIG. 16B. In other words, according to Embodiment 1, it is possible to reduce a rate in which a right-eye image is mixed in the image to be visually recognized as a left-eye image. Accordingly, degradation in the image quality of a stereoscopic image can be suppressed.

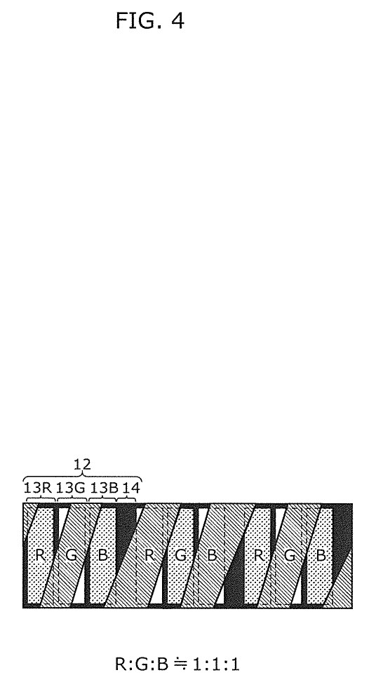

These points will be described in detail with reference to FIG. 4. FIG. 4 is an enlarged view illustrating regions of three pixels in a horizontal direction on the image display panel in FIG. 3A.

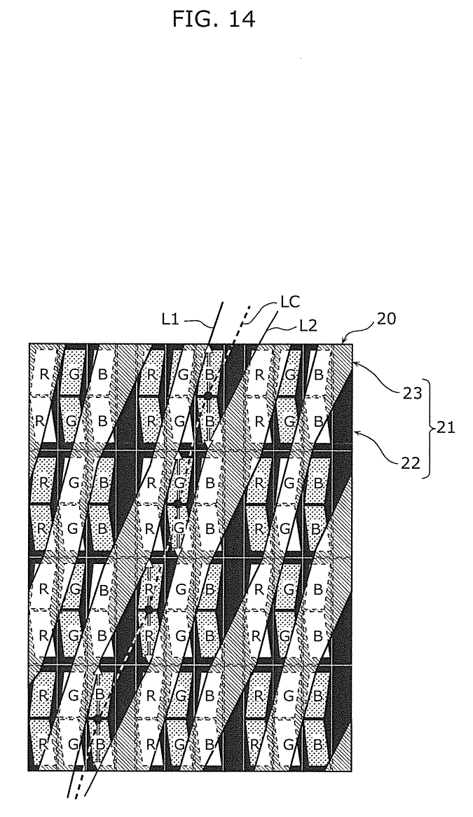

FIG. 4 shows that the image has a lower rate of sub-pixels (white-on-black cells) for displaying a left-eye image and a higher rate of sub-pixels (dotted cells) for displaying a right-eye image than those of FIG. 14. The result shows that an area ratio of the red sub-pixel 13R, the green sub-pixel 13G, and the blue sub-pixel 13B in each of the sub-pixels is approximately 1:1:1 (R:G:B≈1:1:1). Accordingly, it is possible to improve the imbalance in view of each image of RGB sub-pixels, that is, the imbalance in RGB colors. Thus, it is possible to reduce occurrence of the color moire caused by the imbalance in RGB colors, and suppress degradation in the image quality of a right-eye image.

In the image display panel 1 according to Embodiment 1, even when the image separating unit 20 including the slanted parallax barrier 21 is applied to the image display unit 10 in which the sub-pixels (the red sub-pixel 13R, the green sub-pixel 13G, and the blue sub-pixel 13B) included in each of the pixels 12 do not have sizes obtained by equally dividing the pixel 12, each of the boundary lines between the light-transmitting portions 22 and the light-shielding portions 23 in the image separating unit 20 is parallel to the continuous line that connects lines each of which connects the gravity centers of the adjacent sub-pixels in the display unit 11 of the image display unit 10. Thus, it is possible to suppress mixing of one of the right-eye image from the first viewpoint P1 and the left-eye image from the second viewpoint P2 that are observed by the observer 200 to the other image. Since degradation in the image quality of a stereoscopic image can be suppressed, the stereoscopic image of high quality can be displayed.

Furthermore, when the image separating unit 20 includes the slanted parallax barrier 21 as according to Embodiment 1, the light-shielding portions 23 included in the parallax barrier 21 interfere with the light-shielding regions 14 (black matrix, etc) of the image display unit 10, and the observer easily finds moire. However, since the image display panel 1 according to Embodiment 1 can suppress the imbalance in colors, occurrence of the color moire can be suppressed.

(Variation 1 of Embodiment 1)

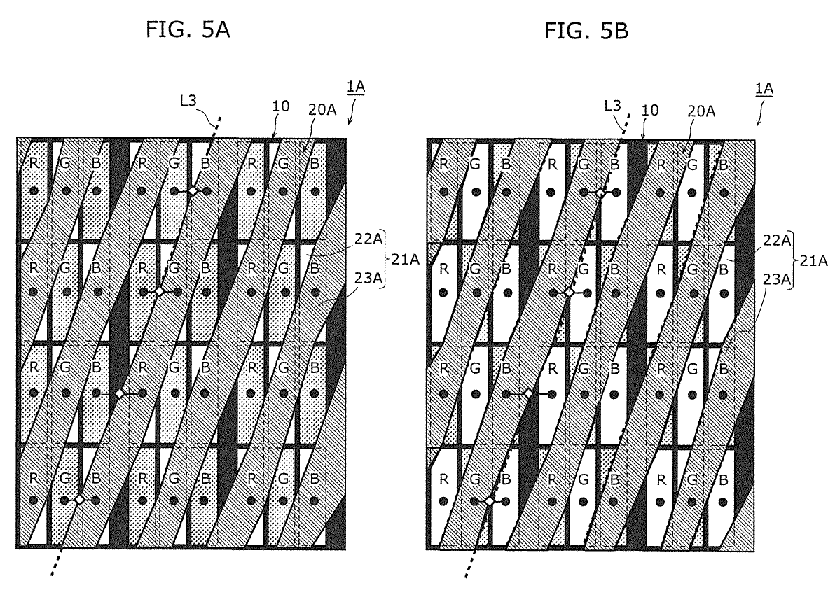

Next, an image display panel 1A according to Variation 1 of Embodiment 1 will be described with reference to FIGS. 5A and 5B. FIGS. 5A and 5B schematically illustrate a relationship between an image display unit and an image separating unit in the image display panel 1A according to Variation 1. FIG. 5A illustrates an image seen from the first viewpoint P1, and FIG. 58 illustrates an image seen from the second viewpoint P2.

The difference between the image display panel 1A according to Variation 1 and the image display panel 1 according to Embodiment 1 is the structure of a parallax barrier in the image separating unit. Except for the structure of the image separating unit, the image display panel 1A has the same structure as that of the image display panel 1. Thus, constituent elements in FIGS. 5A and 5B identical to those in FIGS. 3A and 3B are assigned the same reference signs, and the descriptions are omitted or simplified.

Although the shape of light-transmitting portions 22A (or shape of light-shielding portions 23A) in a parallax barrier 21A of an image separating unit 20A is defined with respect to the gravity centers of the sub-pixels in the image display unit 10 as according to Embodiment 1, the shape of the light-transmitting portions 22A is designed so that each of the boundary lines between the light-transmitting portions 22A and the light-shielding portions 23A becomes a continuous line that connects lines each of which connects midpoints of the gravity centers of the adjacent sub-pixels in the horizontal direction from among the sub-pixels of the entire display unit 11, in the image display panel 1A according to Variation 1.

According to Variation 1, the light-transmitting portions 22A and the light-shielding portions 23A are alternately arranged in the horizontal direction as according to Embodiment 1. Furthermore, the light-transmitting portions 22A are successively open in a diagonal direction with respect to the vertical direction, and each of the light-shielding portions 23A has a predetermined angle with respect to the vertical direction so as to have the same tilt angle as that of the light-transmitting portions 22. Thus, the parallax barrier 21A is also slanted in Variation 1.

In FIGS. 5A and 5B, the gravity center of each of the sub-pixels is represented by a black point (), the midpoint of the gravity centers of the sub-pixels adjacent in the horizontal direction is represented by a white-on-black rectangle (⋄), and a continuous line that connects lines each of which connects the midpoints (⋄) of the gravity centers by a straight line is represented by a dashed line. According to Variation 1, a boundary line between the light-transmitting portion 22A and the light-shielding portion 23A is a continuous line L3 itself that connects lines each of which connects, by a straight line, the midpoints of the gravity centers of the sub-pixels adjacent in the horizontal direction.

Here, FIG. 5A shows that the image observed from the first viewpoint P1 as a right-eye image has a lower rate of unnecessary sub-pixels (white-on-black cells) for displaying a left-eye image and a higher rate of necessary sub-pixels (dotted cells) for displaying the right-eye image than those of FIG. 16A. In other words, according to Variation 1, it is possible to reduce a rate in which a left-eye image is mixed in the image to be visually recognized as a right-eye image. Similarly, FIG. 5B shows that the image observed from the second viewpoint P2 as a left-eye image has a lower rate of unnecessary sub-pixels (dotted cells) for displaying a right-eye image and a higher rate of necessary sub-pixels (white-on-black cells) for displaying the left-eye image than those of FIG. 16B. In other words, according to Variation 1, it is possible to reduce a rate in which a right-eye image is mixed in the image to be visually recognized as a left-eye image.

Furthermore, FIGS. 5A and 5B show that an area ratio of a red sub-pixel, a green sub-pixel, and a blue sub-pixel in each of the sub-pixels is approximately 1:1:1 (R:G:B≈1:1:1), and thus that the imbalance in RGB colors can be substantially improved.

As described above, the image display panel 1A according to Variation 1 produces the same advantages as those according to Embodiment 1. In other words, it is possible to suppress mixing of one of the right-eye image from the first viewpoint P1 and the left-eye image from the second viewpoint P2 that are observed by the observer 200 to the other image. Since degradation in the image quality of a stereoscopic image can be suppressed, the stereoscopic image of high quality can be displayed. Furthermore, since the image display panel 1A can suppress the imbalance in colors, occurrence of the color moire can also be suppressed.

(Variation 2 of Embodiment 1)

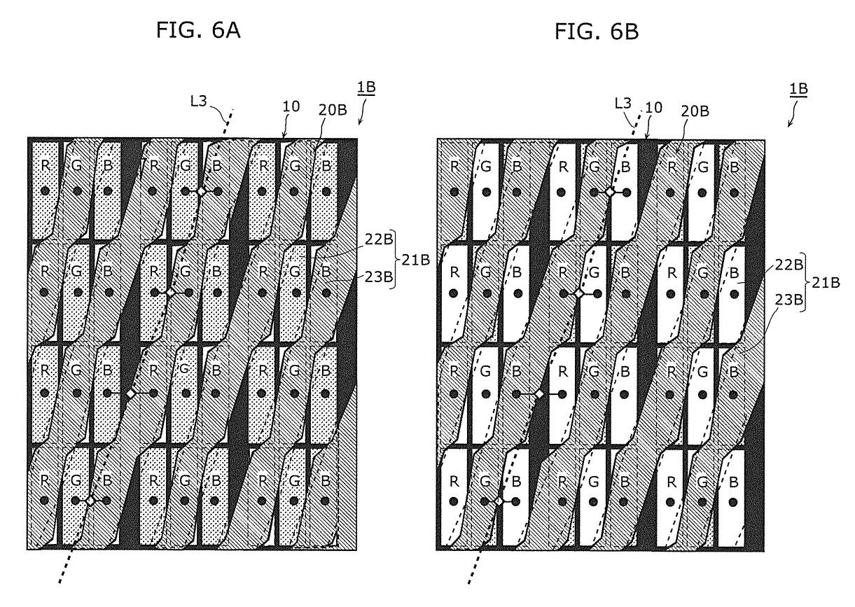

Next, an image display panel 1B according to Variation 2 of Embodiment 1 will be described with reference to FIGS. 6A and 6B. FIGS. 6A and 6B schematically illustrate a relationship between an image display unit 10 and an image separating unit 20B in the image display panel 1B according to Variation 2. FIG. 6A illustrates an image seen from the first viewpoint P1, and FIG. 6B illustrates an image seen from the second viewpoint P2.

The difference between the image display panel 1B according to Variation 2 and the image display panel 1 according to Embodiment 1 is the structure of a parallax barrier in the image separating unit 20B. Except for the structure of the image separating unit 20B, the image display panel 1B has the same structure as that of the image display panel 1. Thus, constituent elements in FIGS. 6A and 6B identical to those in FIGS. 3A and 3B are assigned the same reference signs, and the descriptions are omitted or simplified.

Although the shape of light-transmitting portions 22B (or shape of light-shielding portions 23B) in a parallax barrier 218 of the image separating unit 20B is defined with respect to the gravity centers of the sub-pixels in the image display unit 10 as according to Embodiment 1, the shape of the light-transmitting portions 22B is designed so that (i) each of the boundary lines between the light-transmitting portions 22B and the light-shielding portions 23B becomes a continuous line that connects lines each of which connects midpoints of the gravity centers of the sub-pixels adjacent in the horizontal direction from among the sub-pixels of the entire display unit 11, and (ii) the continuous line has a flexion for increasing an amount of light from the sub-pixels that display one of the right-eye image and the left-eye image, in the image display panel 1A according to Variation 2 as illustrated in FIGS. 6A and 6B. In other words, each of the boundary lines between the light-transmitting portions 22B and the light-shielding portions 23B according to Variation 2 additionally includes a regular pattern or an irregular pattern, based on the boundary lines between the light-transmitting portions 22A and the light-shielding portions 23A according to Variation 1, that is, the continuous line L3 that connects lines each of which connects the midpoints of the gravity centers of the sub-pixels adjacent in the horizontal direction.

Specifically, each of the boundary lines between the light-transmitting portions 22B and the light-shielding portions 238 has a structure in which the continuous line L3 is bent so as to increase an amount of light from the sub-pixels that display one of the right-eye image and the left-eye image, and thus has a zigzag pattern added to the shape of the light-transmitting portions 22A in FIGS. 5A and 5B.

According to Variation 2, the light-transmitting portions 22B and the light-shielding portions 23B are alternately arranged in the horizontal direction as according to Embodiment 1. Furthermore, each of the light-transmitting portions 228 is successively open stepwise in a diagonal direction with respect to the vertical direction, and each of the light-shielding portions 23B is the same as the light-transmitting portions 22A.

In FIGS. 6A and 6B, the gravity center of each of the sub-pixels is represented by a black point (), the midpoint of the gravity centers of the sub-pixels adjacent in the horizontal direction is represented by a white-on-black rectangle (⋄), and a continuous line that connects the midpoints (⋄) of the gravity centers is represented by a dashed line. According to Variation 2, each of the boundary lines between the light-transmitting portions 228 and the light-shielding portions 23B is stretched across the midpoint (⋄) of the gravity centers, with respect to the continuous line L3 that connects the midpoints of the gravity centers of the sub-pixels adjacent in the horizontal direction.

Specifically, a portion of the continuous line L3 that is above the midpoint (⋄) of the gravity centers in one pixel is bent to be stretched in a left direction with respect to the plane of paper, and a portion of the continuous line L3 that is below the midpoint (⋄) of the gravity centers in one pixel is bent to be stretched in a right direction with respect to the plane of paper.

Here, FIG. 6A shows that the image observed from the first viewpoint P1 as a right-eye image has a lower rate of unnecessary sub-pixels (white-on-black cells) for displaying a left-eye image and a higher rate of necessary sub-pixels (dotted cells) for displaying a right-eye image than those of FIG. 5A. Similarly, FIG. 6B shows that the image observed from the second viewpoint P2 as a left-eye image has a lower rate of unnecessary sub-pixels (dotted cells) for displaying a right-eye image and a higher rate of necessary sub-pixels (white-on-black cells) for displaying a left-eye image than those of FIG. 5A. As such, according to Variation 2, it is possible to reduce a rate in which the image to be visually recognized as one of a left-eye image and a right-eye image includes the other image more than that of Variation 1.

As described above, the image display panel 1B according to Variation 2 can suppress mixing of one of the right-eye image from the first viewpoint P1 and the left-eye image from the second viewpoint P2 that are observed by the observer 200 to the other image more than Embodiment 1 and Variation 1 of Embodiment 1. As a result, a stereoscopic image of higher quality can be displayed.

Furthermore, since the image display panel 1B can suppress the imbalance in colors, occurrence of the color moire can be suppressed. Since the light-shielding portions 23B additionally have a zigzag pattern, the occurrence of the color moire can be further effectively suppressed. In other words, with the structure of the light-shielding portions 23B in the image separating unit according to Variation 2, the occurrence of the color moire caused by interference of the light-shielding portions 23B with the light-shielding regions 14 of the image display unit 10 can be substantially suppressed As a result, the occurrence of the color moire can be effectively suppressed.

In creating these patterns, the effect will further increase by putting some thought into designing the shape of light-transmitting portions so that the areas of RGB sub-pixels viewed by a viewer are balanced as much as possible.

Variation 2 is applicable to the boundary lines L1 and L2 between the light-transmitting portion 22 and the light-shielding portions 23 in FIGS. 3A and 3B.

### Embodiment 2

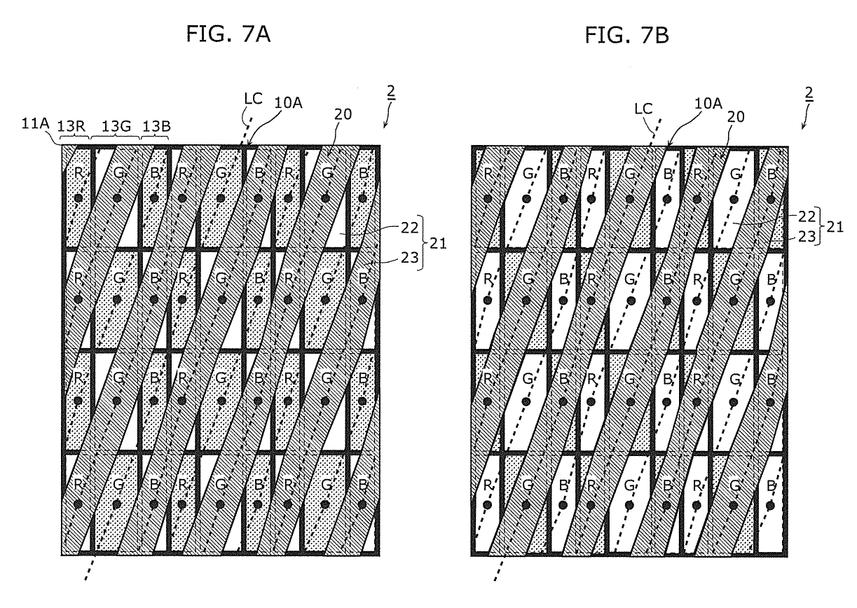

Next, an image display panel 2 according to Embodiment 2 will be described with reference to FIGS. 7A and 7B. FIGS. 7A and 7B schematically illustrate a relationship between an image display unit and an image separating unit in the image display panel 2 according to Variation 2. FIG. 7A illustrates an image seen from the first viewpoint P1, and FIG. 78 illustrates an image seen from the second viewpoint P2.

According to Embodiment 2, the pixel structure of the image display unit of the image display panel 1 is different from that according to Embodiment 1.

As illustrated in FIGS. 7A and 7B, in the image display panel 2 according to Embodiment 2, the pixel structure of a display unit 11A in an image display unit 10A is the same as that according to Embodiment 1 in the sizes of sub-pixels in each pixel that are sizes not equally dividing the pixel. However, the pixel structure of the display unit 11A is different from that according to Embodiment 1 in that among the sub-pixels included in the pixel, a sub-pixel corresponding to one of the colors is different in size from a sub-pixel corresponding to an other one of the colors.

According to Embodiment 2, the pixel sizes of RGB sub-pixels included in each pixel in a horizontal direction are different from each other. Specifically, as illustrated in FIGS. 7A and 7B, the pixel size of green sub-pixels 13G in the middle of the pixels in the horizontal direction is different from the pixel sizes of red sub-pixels 13R and blue sub-pixels 13B.

Although the pixel size of the green sub-pixels 13G is different from the pixel sizes of the other sub-pixels in the horizontal direction, the pixel size of the red sub-pixels 13R or the blue sub-pixels 13B may be different from the pixel sizes of the other sub-pixels in the horizontal direction. Furthermore, as illustrated in FIGS. 7A and 7B, the pixel size of the red sub-pixels 13R is identical to that of the blue sub-pixels 13B in the horizontal direction, the pixel sizes of all the RGB sub-pixels may be different from each other. Furthermore, according to Embodiment 2, no light-shielding region as a busbar formation region exists, and the light-shielding regions (black matrices) between the light-emitting areas of the sub-pixels have the same width.

Furthermore, an image separating unit 20 according to Embodiment 2 is structured in the same manner as the image separating unit 20 in FIGS. 3A and 3B according to Embodiment 1. In other words, each boundary line between light-transmitting portions 22 and light-shielding portions 23 in the image separating unit 20 according to Embodiment 2 is identical to a line determined by moving, parallel to the vertical direction by Sh/2, a continuous line LC that connects predetermined positions of sub-pixels that are adjacent in the diagonal direction and are included in the sub-pixels of the entire display unit 11 (the red sub-pixels 13R, the green sub-pixels 13G, and the blue sub-pixels 13B). According to Embodiment 2, the predetermined positions are gravity centers of the sub-pixels, and each of the boundary lines between the light-transmitting portions 22 and the light-shielding portions 23 is parallel to the continuous line that connects lines each of which connects the gravity centers of the sub-pixels that are adjacent in the diagonal direction. In FIGS. 7A and 7B, the gravity center of each of the sub-pixels is represented by a black point ().

According to Embodiment 2, the light-transmitting portions 22 and the light-shielding portions 23 are alternately arranged in the horizontal direction. Furthermore, the light-transmitting portions 22 are successively open in the diagonal direction with respect to the vertical direction, and each of the light-shielding portions 23 has a predetermined angle with respect to the vertical direction so as to have the same tilt angle as that of the light-transmitting portions 22. Thus, the parallax barrier 21 is also slanted in Embodiment 2.

Here, FIG. 7A shows that the image observed from the first viewpoint P1 as a right-eye image has a lower rate of unnecessary sub-pixels (white-on-black cells) for displaying a left-eye image and a higher rate of necessary sub-pixels (dotted cells) for displaying the right-eye image than those of FIG. 18. Similarly, FIG. 7B shows that the image observed from the second viewpoint P2 as a left-eye image has a lower rate of unnecessary sub-pixels (dotted cells) for displaying a right-eye image and a higher rate of necessary sub-pixels (white-on-black cells) for displaying the left-eye image. As such, according to Embodiment 2, it is possible to reduce a rate in which the image to be visually recognized as one of a left-eye image and a right-eye image includes the other image.

As described above, the image display panel 2 according to Embodiment 2 produces the same advantages as those according to Embodiment 1. In other words, it is possible to suppress mixing of one of the right-eye image from the first viewpoint P1 and the left-eye image from the second viewpoint P2 that are observed by the observer 200 to the other image. As a result, since degradation in the image quality of a stereoscopic image can be suppressed, the stereoscopic image of high quality can be displayed. Furthermore, since the image display panel 2 can suppress the imbalance in colors, occurrence of the color moire can be suppressed.

(Variation 1 of Embodiment 2)

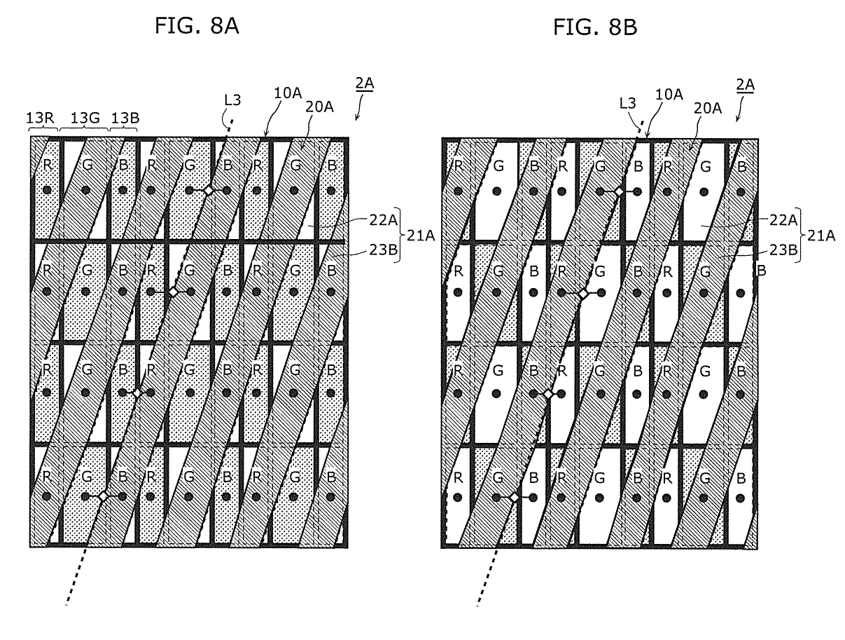

Next, an image display panel 2A according to Variation 1 of Embodiment 2 will be described with reference to FIGS. 8A and 8B. FIGS. 8A and 8B schematically illustrate a relationship between an image display unit and an image separating unit in the image display panel 2A according to Variation 1 of Embodiment 2. FIG. 8A illustrates an image seen from the first viewpoint P1, and FIG. 8B illustrates an image seen from the second viewpoint P2.

The difference between the image display panel 2A according to Variation 1 and the image display panel 2 according to Embodiment 2 is the structure of a parallax barrier in the image separating unit. Except for the structure of the image separating unit, the image display panel 2A has the same structure as that of the image display panel 1 according to Embodiment 2. Thus, constituent elements in FIGS. 8A and 8B identical to those in FIGS. 7A and 78 are assigned the same reference signs, and the descriptions are omitted or simplified.

As illustrated in FIGS. 8A and 8B, light-transmitting portions 22A and light-shielding portions 23A in a parallax barrier 21A of the image separating unit 20A in the image display panel 2A according to Variation 1 are structured in the same manner as those according to Variation 1 of Embodiment 1. The shape of the light-transmitting portions 22A (light-shielding portions 23A) in the image separating unit 20A is designed so that each of the boundary lines between the light-transmitting portions 22A and the light-shielding portions 23A becomes a continuous line that connects lines each of which connects midpoints of the gravity centers of the sub-pixels adjacent in the horizontal direction from among the sub-pixels.

In FIGS. 8A and 8B, the gravity center of each of the sub-pixels is represented by a black point (), the midpoint of the gravity centers of the sub-pixels adjacent in the horizontal direction is represented by a white-on-black rectangle (⋄), and a continuous line that connects the midpoints (⋄) of the gravity centers is represented by a dashed line. According to Variation 1, a boundary line between the light-transmitting portion 22A and the light-shielding portion 23A is a continuous line L3 itself that connects lines each of which connects the midpoints of the gravity centers of the sub-pixels adjacent in the horizontal direction.

Focusing on the sub-pixels (green sub-pixels 13G) that are larger in the horizontal direction, it is clear that the light-transmitting/shielding balance is more improved than the conventional one. As illustrated in FIG. 8A, by setting the shape of the light-transmitting portions 22A, the image observed from the first viewpoint P1 as a right-eye image has a lower rate of unnecessary sub-pixels (white-on-black cells) for displaying a left-eye image and a higher rate of necessary sub-pixels (dotted cells) for displaying the right-eye image than those of FIG. 16A. Similarly, FIG. 8B shows that the image observed from the second viewpoint P2 as a left-eye image has a lower rate of unnecessary sub-pixels (dotted cells) for displaying a right-eye image and a higher rate of necessary sub-pixels (white-on-black cells) for displaying the left-eye image than those of FIG. 16B. As such, according to Variation 1, it is possible to reduce a rate in which the image to be visually recognized as one of a left-eye image and a right-eye image includes the other image.

As described above, the image display panel 2A according to Variation 1 produces the same advantages as those according to Embodiment 2. In other words, it is possible to suppress mixing of one of the right-eye image from the first viewpoint P1 and the left-eye image from the second viewpoint P2 that are observed by the observer 200 to the other image. As a result, since degradation in the image quality of a stereoscopic image can be suppressed, the stereoscopic image of high quality can be displayed. Furthermore, since the image display panel 2A can suppress the imbalance in colors, occurrence of the color moire can be reduced.

(Variation 2 of Embodiment 2)

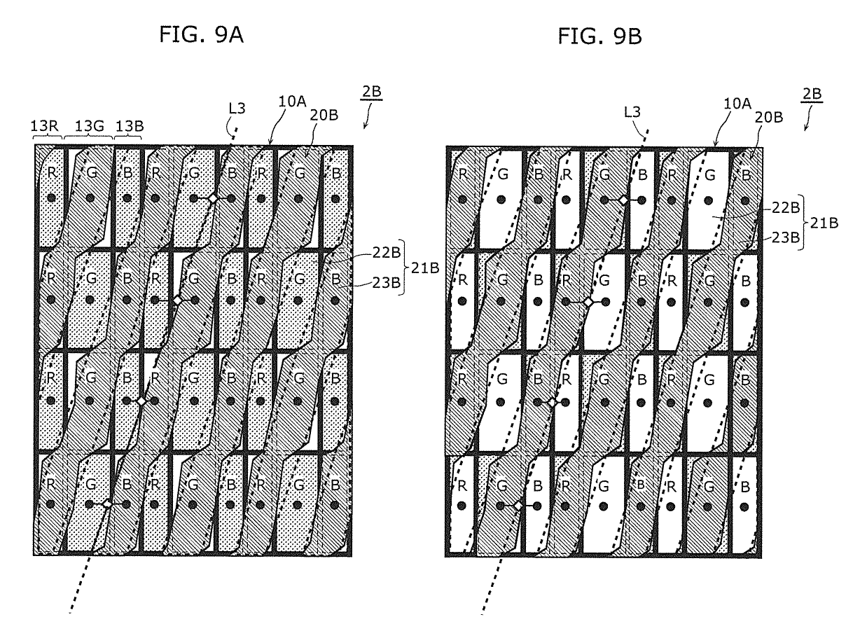

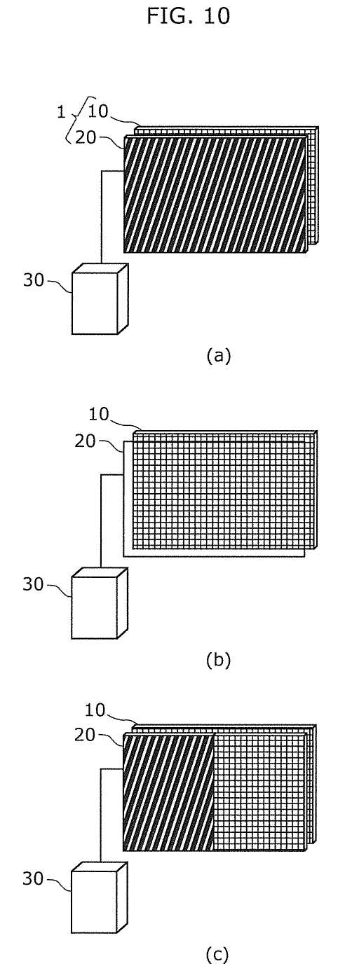

Next, an image display panel 28 according to Variation 2 of Embodiment 2 will be described with reference to FIGS. 9A and 98. FIGS. 9A and 9B schematically illustrate a relationship between an image display unit and an image separating unit 20B in the image display panel 2B according to Variation 2 of Embodiment 2. FIG. 9A illustrates an image seen from the first viewpoint P1, and FIG. 9B illustrates an image seen from the second viewpoint P2.

The difference between the image display panel 2B according to Variation 2 and the image display panel 2 according to Embodiment 2 is the structure of a parallax barrier in the image separating unit 20B. Except for the structure of the image separating unit 20B, the image display panel 2B has the same structure as that of the image display panel 2 according to Embodiment 2. Thus, constituent elements in FIGS. 9A and 9B identical to those in FIGS. 7A and 7B are assigned the same reference signs, and the descriptions are omitted or simplified.

As illustrated in FIGS. 9A and 9B, light-transmitting portions 22B and light-shielding portions 23B in a parallax barrier 218 of the image separating unit 20B are structured in the same manner as those according to Variation 2 of Embodiment 1. The shape of the light-transmitting portions 22B is designed so that (i) each of the boundary lines between the light-transmitting portions 228 and the light-shielding portions 23B becomes a continuous line that connects lines each of which connects midpoints of the gravity centers of the sub-pixels adjacent in the horizontal direction from among the sub-pixels, and (ii) the continuous line has a flexion for increasing an amount of light from the sub-pixels that display one of the right-eye image and the left-eye image, in the parallax barrier 21B of the image separating unit 20B according to Variation 2.

In other words, each of the boundary lines between the light-transmitting portions 22B and the light-shielding portions 23B according to Variation 2 additionally includes a regular pattern or an irregular pattern, based on a boundary line between the light-transmitting portion 22A and the light-shielding portion 23A according to Variation 2 of Embodiment 1, that is, the continuous line L3 that connects, by a straight line, the midpoints of the gravity centers of the sub-pixels adjacent in the horizontal direction.

Specifically, each of the boundary lines between the light-transmitting portions 22B and the light-shielding portions 23B according to Variation 2 has a structure in which the continuous line L3 is bent so as to increase an amount of light from the sub-pixels that display one of the right-eye image and the left-eye image, and thus has a zigzag pattern added to the shape of the light-transmitting portions 22A in FIGS. 5A and 5B.

Here, FIG. 9A shows that the image observed from the first viewpoint P1 as a right-eye image has a lower rate of unnecessary sub-pixels (white-on-black cells) for displaying a left-eye image and a higher rate of necessary sub-pixels (dotted cells) for displaying the right-eye image than those of FIG. 8A. Similarly, FIG. 9B shows that the image observed from the second viewpoint P2 as a left-eye image has a lower rate of unnecessary sub-pixels (dotted cells) for displaying a right-eye image and a higher rate of necessary sub-pixels (white-on-black cells) for displaying the left-eye image than those of FIG. 8A. As such, according to Variation 2 of Embodiment 2, it is possible to further reduce a rate in which the image to be visually recognized as one of a left-eye image and a right-eye image includes the other image more than that of Variation 1 according to Embodiment 2.

As described above, the image display panel 2B according to Variation 2 can suppress mixing of one of the right-eye image from the first viewpoint P1 and the left-eye image from the second viewpoint P2 that are observed by the observer 200 to the other image more than Embodiment 2 and Variation 1 of Embodiment 2. As a result, a stereoscopic image of higher quality can be displayed.

Since the light-shielding portions 23B additionally have a zigzag pattern, the balance in RGB colors can be improved and the color moire can be suppressed.

In creating these patterns, the effect will further increase by designing the shape of light-transmitting portions so that the areas of RGB sub-pixels viewed by a viewer are balanced as much as possible.

Furthermore, when light-emitting elements of RGB colors have differences in performance in an image display unit included in an organic EL display, the sizes of RGB sub-pixels are sometimes intentionally changed. As a result, there are cases where an area ratio of the RGB sub-pixels in each pixel is not a ratio obtained by equally dividing the pixel. Here, it is desired that an image (right-eye image, left-eye image) viewed through the image separating unit has approximately the same area ratio of the RGB sub-pixels in the pixel structure of the image display unit.

Variation 2 is applicable to the boundary lines between the light-transmitting portions 22 and the light-shielding portions 23 in FIGS. 7A and 7B.

### Embodiment 3

Next, an image display device according to Embodiment 3 will be described with reference to FIG. 10. FIG. 10 illustrates an outline configuration of the image display device according to Embodiment 3. The image display device can be implemented as a liquid crystal display, a plasma display, and an organic EL display, and for example, can use the image display panel 1 according to Embodiment 1. Using the image display panel according to Embodiment 3, a method for displaying an image according to the present invention can be easily applied to various devices, and a stereoimage with superior color balance and less color moire can be viewed.

Furthermore, as illustrated in (a) to (c) of FIG. 10, an image separation control unit 30 that controls the characteristics of the image separating unit 20 is added to the image display panel 1 in the image display device according to Embodiment 3.

The image separation control unit 30 externally changes the pattern of the parallax barrier of the image separating unit 20 according to a purpose, in order to achieve an image display panel that displays a desired image. Specifically, since the image quality of a stereoscopic image is changed according to change in an amount of moire and an amount of crosstalk depending on a pattern (shape of the light-transmitting portions and the light-shielding portions) of the parallax barrier of the image separating unit 20, it is preferable to change the pattern of the parallax barrier according to change in the image quality.

Specifically, the image separating unit 20 is set depending on its position so as to flexibly switch between a complete light-shielding state (light-transmission rate=0%) and a complete light-transmission state (light-transmission rate=100%), that is, so as to change the pattern of the parallax barrier according to a purpose. For example, an open width of light-transmitting portions and a light-shielding width of light-shielding portions can be changed.

The means for changing the pattern of the parallax barrier is for example, using, as the image separating unit 20, a liquid crystal shutter panel including (i) a first light-shielding substrate on which a transparent electrode to be a pattern of a light-shielding portion is formed, (ii) a second light-shielding substrate facing the first light-shielding substrate, (iii) a liquid crystal layer formed between the first light-shielding substrate and the second light-shielding substrate, and (iv) two polarizers provided to sandwich the liquid crystal layer. The pattern of the light-shielding portions or light-transmitting portions can be freely changed by determining the light-shielding portions and the light-transmitting portions as either portions that apply a voltage to the transparent electrode or portions that do not apply a voltage to the transparent electrode. Accordingly, a pattern of the parallax barrier of the image separating unit 20 can be changed to the pattern according to the present invention depending on a situation, and the observer can obtain a desired stereoscopic image.

Furthermore, the image separation control unit 30 according to Embodiment 3 controls a display image on the image display panel by outputting, to the image separating unit 20, a 2D/3D switching signal for switching between a stereoscopic image (3D display) and a 2D image (3D display).

Specifically, when the observer views a stereoscopic image, as illustrated in (a) of FIG. 10, the image separation control unit 30 causes the image separating unit 20 to generate a parallax barrier so that the light-shielding portions 23 function, and to separate a composite image to be displayed on the image display unit 10 into a right-eye image and a left-eye image. Accordingly, the observer can view a stereoscopic image three-dimensionally displayed on an entire display.

Furthermore, when the observer views a 2D image, as illustrated in (b) of FIG. 10, the light-shielding portions 23 are disabled, that is, the image separation control unit 30 controls the image separating unit 20 so that the light-shielding portions 23 do not exercise a light-shielding function. As a result, the 2D image to be displayed on the image display unit 10 can be entirely transmitted without being shielded by the image separating unit 20. Accordingly, the observer can view a 2D image two-dimensionally displayed on an entire display.

As such, controlling the image separating unit 20 using the image separation control unit 30 makes it possible for the observer can view a stereoscopic image and a 2D image while switching between them. Whether or not the light-shielding portions 23 exercise the light-shielding function can be controlled by controlling a voltage to be applied to transparent electrodes having a pattern corresponding to the light-shielding portions 23, for example, when the image separating unit 20 is a liquid crystal shutter panel.

Furthermore, both the stereoscopic image and the 2D image may be simultaneously viewed according to Embodiment 3. For example, the image separation control unit 30 controls the image separating unit 20 so that a left half of a screen can be three-dimensionally viewed as a stereoscopic image by the naked eye, and a right half of the screen can be viewed as a 2D image of high image quality as illustrated in (c) of FIG. 10. Here, the light-shielding portions 23 of the image separating unit 20 are set to exercise the light-shielding function at the left half of the screen and do not exercise the light-shielding function at the right half of the screen, by controlling the image separating unit 20 using the image separation control unit 30. Accordingly, the observer can view an image including a 2D image and a 3D image in the case of (c) of FIG. 10.

(Variations)

Although the method for displaying a stereoscopic image, the image display panel, and the image display device for displaying a stereoscopic image according to the present invention are hereinbefore described based on Embodiments 1 to 3, the present invention is not limited to these Embodiments. Variation 1 of the present invention will be described hereinafter.

(Variation 1)

Although Embodiments 1 to 3 describe the pixel structure in which RGB sub-pixels are arranged in a horizontal direction, the present invention is not limited to such a pixel structure. For example, the same is applicable to the pixel structure in which the RGB sub-pixels are arranged in a vertical direction.

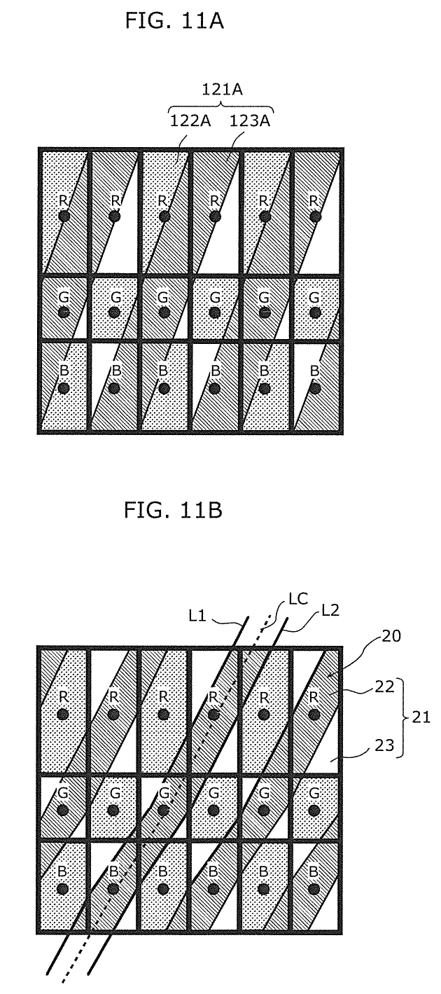

Variation 1 of the present invention will be described hereinafter with reference to FIGS. 11A and 11B. FIG. 11A schematically illustrates a relationship between an image display unit and an image separating unit in a first conventional image display panel. In contrast, FIG. 11B schematically illustrates a relationship between an image display unit and an image separating unit in an image display panel according to Variation 1 of the present invention.

FIGS. 11A and 11B illustrate an example in which the structure of the image separating unit according to Embodiment 1 is applied to the image display unit having the pixel structure in which the RGB sub-pixels are arranged in a vertical direction. FIGS. 11A and 11B both illustrate an image seen from the first viewpoint P1.

FIG. 11A clarifies that in the conventional structure with a parallax barrier 121A including light-transmitting portions 122A and light-shielding portions 123A having straight boundary lines in-between, the image observed from the first viewpoint P1 as a right-eye image includes many unnecessary sub-pixels (white-on-black cells) for displaying a left-eye image.

In contrast, as illustrated in FIG. 11B, according to Variation 1, each of boundary lines between light-transmitting portions 22 and light-shielding portions 23 in the image separating unit 20 is determined by moving, parallel to the vertical direction, a continuous line LC that connects, by a straight line, lines each of which passes through the gravity centers of the sub-pixels that are adjacent in the diagonal direction as according to Embodiment 1. Specifically, two boundary lines L1 and L2 (first and second parallel lines) between adjacent light-shielding portions 23 and an light-transmitting portion 22 are determined by moving, parallel to the vertical direction, the continuous line LC that connects the gravity centers of the sub-pixels that are adjacent in the diagonal direction. Accordingly, a rate in which unnecessary sub-pixels (white-on-black cells) for displaying a left-eye image are included in the image observed from the first viewpoint P1 as a right-eye image can be reduced. Furthermore, a rate in which unnecessary sub-pixels (dotted cells) for displaying a right-eye image are included in the image observed from the second viewpoint P2 as a left-eye image can be reduced. As such, Variation 1 can make it possible to effectively separate the signal (right-eye image) at the first viewpoint P1 from the signal (left-eye image) at the second viewpoint P2 as according to Embodiment 1.

The pixel structure of the image separating unit according to Variation 1 of Embodiment 1 may be applied to that of the image display unit according to Variation 1 herein. In other words, each of the boundary lines between the light-transmitting portions 22 and the light-shielding portions 23 may become a continuous line that connects lines each of which connects midpoints of the gravity centers of the sub-pixels adjacent in the horizontal direction from among the sub-pixels. Alternatively, the pixel structure of the image separating unit according to Variation 2 of Embodiment 1 may be applied to that of the image display unit according to Variation 1 herein. In other words, each of the boundary lines between the light-transmitting portions 22 and the light-shielding portions 23 may become a continuous line that has a flexion for increasing an amount of light from the sub-pixels that display one of the right-eye image and the left-eye image.

(Variation 2)

Although Embodiments 1 to 3 describe the pixel structure in which the gravity centers of the sub-pixels approximately match the gravity centers of light emitting regions of the sub-pixels, the present invention is not limited to such a pixel structure. For example, the same is applicable to the pixel structure in which the gravity centers of the sub-pixels do not match the gravity centers of the light emitting regions of the sub-pixels.

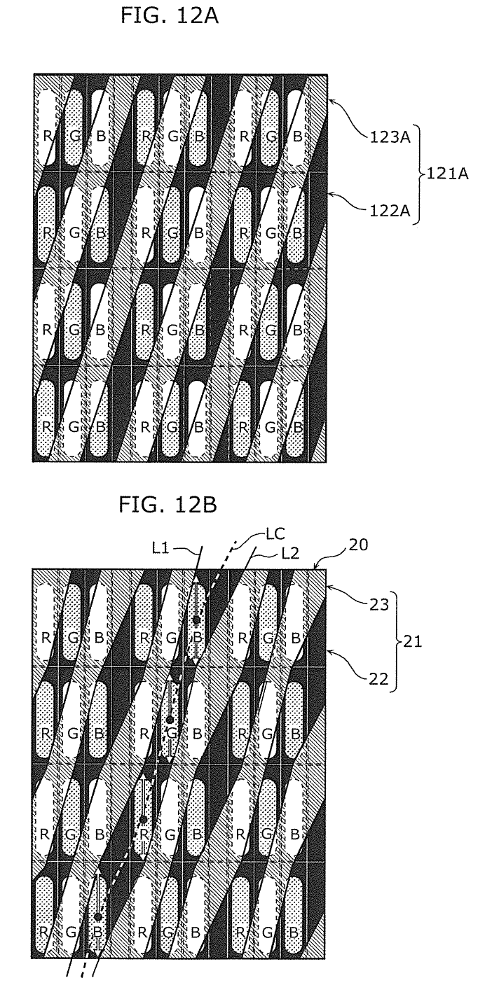

Variation 2 of the present invention will be described hereinafter with reference to FIGS. 12A and 12B. FIG. 12A schematically illustrates a relationship between an image display unit and an image separating unit in a second conventional image display panel. In contrast, FIG. 12B schematically illustrates a relationship between an image display unit and an image separating unit in an image display panel according to Variation 2 of the present invention.

FIGS. 12A and 12B illustrate a case where the gravity centers of the sub-pixels do not match the gravity centers of the light emitting regions because the light emitting regions are vertically displaced (to the lower side according to Variation 2) in the sub-pixels of the pixels of the image display unit. FIGS. 11A and 11B both illustrate an image seen from the first viewpoint P1.

The light emitting regions are vertically displaced in the sub-pixels, for example, when a metal electrode (metal wire) formed in each of the sub-pixels is shielded by a black matrix. Accordingly, the upper region or the lower region of each of the sub-pixels becomes a black matrix region, and thus the gravity centers of light emitting regions are displaced from the gravity centers of the sub-pixels.

FIG. 12A clarifies that in a pixel structure with a conventional parallax barrier 121A including light-transmitting portions 122A and light-shielding portions 123A having straight boundary lines in-between, the image observed from the first viewpoint P1 as a right-eye image includes many unnecessary sub-pixels (white-on-black cells) for displaying a left-eye image.

In contrast, as illustrated in FIG. 12B, according to Variation 2, each of boundary lines between light-transmitting portions 22 and light-shielding portions 23 in an image separating unit 20 is determined by moving, parallel to the vertical direction, a continuous line LC that connects, by a straight line, lines each of which passes through the gravity centers of the light emitting regions that are adjacent in the diagonal direction. Specifically, two boundary lines L1 and L2 (first parallel line and second parallel line) between light-shielding portions 23 and an light-transmitting portion 22 are determined by moving, parallel to the vertical direction, the continuous line LC that connects the gravity centers of the light emitting regions of the sub-pixels that are adjacent in the diagonal direction. In other words, although Embodiment 1 defines the boundary lines between the light-transmitting portions 22 and the light-shielding portions 23 with respect to the gravity centers of the sub-pixels, Variation 2 defines the boundary lines between the light-transmitting portions 22 and the light-shielding portions 23 with respect to the gravity centers of the light emitting regions.

Accordingly, a rate in which unnecessary light emitting regions (white-on-black cells) for displaying a left-eye image are included in the image viewed from the first viewpoint P1 as a right-eye image can be reduced. Furthermore, a rate in which unnecessary light emitting regions (dotted cells) for displaying a right-eye image are included in the image viewed from the second viewpoint P2 as a left-eye image can be reduced. As such, Variation 2 can make it possible to effectively separate the signal (right-eye image) at the first viewpoint P1 from the signal (left-eye image) at the second viewpoint P2.

As described above, it is possible to suppress mixing of one of the right-eye image and the left-eye image to the other image according to Variation 2. As a result, since degradation in the image quality of a stereoscopic image can be suppressed, the stereoscopic image of high quality can be displayed. Furthermore, since the image display panel can suppress the imbalance in colors, occurrence of the color moire can be suppressed.

The pixel structure of the image separating unit in FIGS. 5A and 7A according to Variations 1 and 2 of Embodiment 1 may be applied to that of the image display unit according to Variation 2 herein. In other words, each of the boundary lines between the light-transmitting portions 22 and the light-shielding portions 23 may become a continuous line that connects lines each of which connects midpoints of the gravity centers of the light emitting regions adjacent in the horizontal direction, and the continuous line may have a flexion for increasing an amount of light from the sub-pixels.

Furthermore, although each of the upper portion and the lower portion of the light emitting region has a curvature according to Variation 2, it may be rectangular as according to Embodiments 1 and 2. Conversely, the shape of the light emitting region may be the one illustrated in FIG. 12B in Embodiments 1 and 2 and its Variations.

(Variation 3)

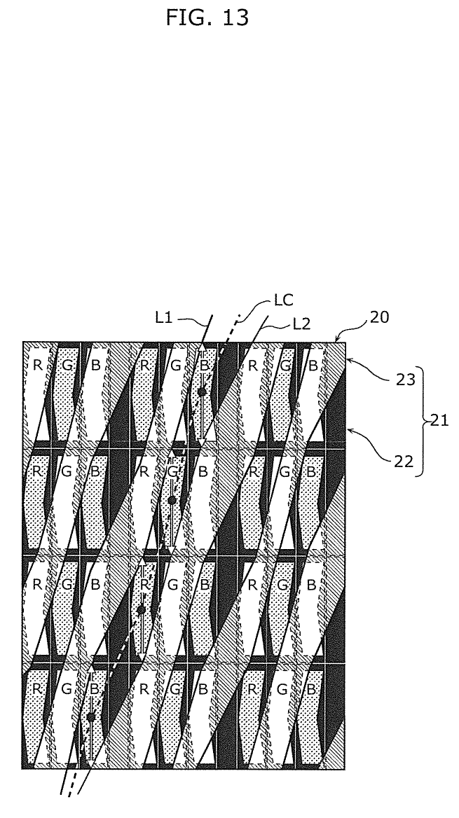

Furthermore, the shape of a light emitting region of each of sub-pixels in a plan view is not limited to those of Embodiments 1 to 3 and its Variations, and the shape may be bent so as to have a dogleg shape as illustrated in FIG. 13. FIG. 13 schematically illustrates a relationship between an image display unit and an image separating unit in an image display panel according to Variation 3 of the present invention. FIG. 13 illustrates an image seen from the first viewpoint P1.

Even when the shape of the light emitting region in the plan view is the one illustrated in FIG. 13, the shape of the light-transmitting portions of the image separating unit in FIG. 3A (defined by the gravity centers of the sub-pixels adjacent in a diagonal direction), the shape of the light-transmitting portions of the image separating unit in FIGS. 5A and 7A (defined by the gravity centers of the sub-pixels adjacent in a horizontal direction), or the shape of the light-transmitting portions of the image separating unit in FIG. 12A (defined by the gravity centers of the light emitting regions) are applicable.

Variation 2 of the present invention will be described hereinafter with reference to FIGS. 12A and 12B. FIG. 12A schematically illustrates a relationship between an image display unit and an image separating unit in a second conventional image display panel. In contrast, FIG. 12B schematically illustrates a relationship between an image display unit and an image separating unit in an image display panel according to Variation 2 of the present invention.

As described above, it is possible to suppress mixing of one of the right-eye image and the left-eye image to the other image according to Variation 2. As a result, since degradation in the image quality of a stereoscopic image can be suppressed, the stereoscopic image of high quality can be displayed. Furthermore, since the image display panel can suppress the imbalance in colors, occurrence of the color moire can be suppressed also according to Variation 3.

(Variation 4)

Furthermore, the shape of a light emitting region of each of sub-pixels in a plan view may be the one illustrated in FIG. 14. FIG. 14 schematically illustrates a relationship between an image display unit and an image separating unit in an image display panel according to Variation 4 of the present invention. FIG. 14 illustrates an image seen from the first viewpoint P1.

As illustrated in FIG. 14, the light emitting region of each of the sub-pixels may be divided into portions. FIG. 14 illustrates an example in which the light emitting regions in FIG. 13 are divided into upper and lower portions. As such, when the light emitting regions are divided into portions, the light emitting regions (divided light emitting regions) are collectively regarded as one light emitting region, so that the shape of the light-transmitting portions of the image separating unit can be defined with respect to the gravity center of the one light emitting region. In other words, similarly as illustrated in FIG. 12B, each of the boundary lines between the light-transmitting portions 22 and the light-shielding portions 23 in the image separating unit 20 can be determined by moving, parallel to the vertical direction, the continuous line LC that connects, by a straight line, lines that pass through the gravity center of the light emitting region (light emitting regions that are adjacent in the diagonal direction).

The pixel structure of the image separating unit in FIGS. 5A and 7A according to Variations 1 and 2 of Embodiment 1 may be applied to that of the image separating unit according to Variation 4 herein. In other words, each of the boundary lines between the light-transmitting portions 22 and the light-shielding portions 23 may become a continuous line that connects lines that connect the midpoint of the gravity center of the light emitting region (light emitting regions that are adjacent in the horizontal direction), and the boundary line may have a flexion for increasing an amount of light from the sub-pixels.

(Variation 5)

Although Embodiments 1 to 3 and its Variations describe an image display device allowing the viewer to stereoscopically view an image by the naked eye using a parallax barrier method, the technique according to Variation 5 is applicable to an image display device allowing the viewer to stereoscopically view an image using a lenticular method. The image display device using the lenticular method uses not a parallax barrier but a lenticular lens as an image separating unit. The lenticular lens is obtained by slanting semi-cylindrical lenses at a predetermined angle and horizontally arranging the lenses. In other words, each of the lenses has a curvature in a horizontal direction and does not have a curvature in a vertical direction.

Here, the adjacent lenses (portion at which the adjacent lenses are in contact with each other) may have the shape of the boundary lines between the light-transmitting portions and the light-shielding portions according to Embodiments 1 to 3 and its Variations of the present invention. For example, the boundary lines between the adjacent lenses may be determined (i) by moving, parallel to the vertically direction, the continuous line that connects lines each of which connects the gravity centers of the sub-pixels (or light emitting regions) that are adjacent in the diagonal direction, (ii) to be a continuous line that connects lines each of which connects midpoints of the gravity centers of the sub-pixels (or light emitting regions) adjacent in the horizontal direction, or (iii) to be a continuous line having a flexion for increasing an amount of light from the sub-pixels.

Since it is possible to suppress mixing of one of the right-eye image and the left-eye image to the other image, the stereoscopic image of high quality can be displayed. Furthermore, since the image display panel can suppress the imbalance in colors, occurrence of the color moire can be reduced.

(Others)

According to Embodiments 1 to 3 and its Variations, the positions of the gravity centers of sub-pixels or light emitting regions do not have to be exact, and the lengths of the sub-pixels with a tolerance rating of approximately ±10 percent in vertical, horizontal, and diagonal directions are acceptable.

Furthermore, designing the shapes of light-transmitting portions in the image separating unit according to Embodiments 1 to 3 and its Variations in consideration of having manufacturing error in manufacturing patterns of parallax barriers makes it possible to further suppress the degradation in image quality.

Furthermore, although Embodiments 1 to 3 and its Variations exemplify the parallax barrier method of two views when the number of views is two, even when the number of views exceeds two, the present invention is applicable. For example, the parallax barrier method may be for multiple views exceeding two views, such as a parallax barrier method for four views.

Furthermore, although Embodiments 1 to 3 and its Variations exemplify that sub-pixels included in each pixel are of three RGB colors and are sequentially arranged in a horizontal or vertical direction in the pixel structure, the present invention is applicable to other color formations or pixel structures. For examples, each pixel may include four colors of R, G, B, and white (W). The pixels of a display unit are not limited to color pixels but may be monochrome pixels.

Furthermore, Embodiments 1 to 3 and its Variations exemplify, not limited to, formation of a busbar when light-shielding regions (black matrices) have a larger width in each pixel. The present invention is applicable even when the light-shielding regions have a larger width in each pixel for another purpose.

Furthermore, although Embodiments 1 to 3 and its Variations describe parallax barriers using a liquid crystal shutter panel, as long as the image separating unit can selectively switch between transmission and non-transmission for a composite image, the image separating unit is not limited to the liquid crystal shutter panel.

Without departing from the scope of the present invention, the present invention includes an embodiment with some modifications on Embodiments that are conceived by a person skilled in the art, and another embodiment obtained through arbitrary combinations of the constituent elements of different Embodiments in the present invention.

### INDUSTRIAL APPLICABILITY

The method for displaying an image, the image display panel, and the image display device according to the present invention can display an image with less moire and degradation in image quality, and, in particular, are widely applicable to image display devices using parallax barriers.

### REFERENCE SIGNS LIST

1, 1A, 2, 2A Image display panel
10, 10A, 10B, 110, 110A, 110B Image display unit
11, 11A, 111 Display unit
12, 112, 112A Pixel
13R, 113R Red sub-pixel
13G, 113G Green sub-pixel
13B, 113B Blue sub-pixel
14 Light-shielding region
20, 20A, 20B, 120, 120A Image separating unit
21, 21A, 21B, 121, 121A Parallax barrier
22, 22a, 22A, 22B, 122, 122A Light-transmitting portion
23, 23a, 23b, 23A, 23B, 123, 123A Light-shielding portion
30 Image separation control unit
40 Format conversion unit
100 Image observation region
130 Camera
140 Format conversion unit
200 Observer
300 Subject

1. A method for displaying an image using (i) an image display unit that includes a plurality of pixels arranged in a horizontal direction and a vertical direction and displays a composite image including a plurality of different images and (ii) an image separating unit that faces the image display unit and separates the composite image displayed on the image display unit into the different images using light-transmitting portions that transmit light and light-shielding portions that shield the light, the light-transmitting portions and the light-shielding portions being alternately arranged in the horizontal direction,
wherein each of the pixels includes a plurality of sub-pixels each including a light emitting region,
the sub-pixels in each of the pixels have sizes different from sizes obtained by equally dividing the pixel,
the light-transmitting portions are open in a diagonal direction with respect to the vertical direction, and
each of boundary lines between the light-transmitting portions and the light-shielding portions is determined (i) by moving parallel a continuous line that connects lines each of which connects gravity centers of adjacent sub-pixels or adjacent light emitting regions that are included in the sub-pixels or (ii) to be a continuous line that connects lines each of which connects midpoints of the gravity centers of the adjacent sub-pixels or the adjacent light emitting regions.

2. An image display panel, comprising:
an image display unit that includes a plurality of pixels arranged in a horizontal direction and a vertical direction, and configured to display a composite image including a plurality of different images; and
an image separating unit that faces the image display unit, and configured to separate the composite image displayed on the image display unit into the different images using light-transmitting portions that transmit light and light-shielding portions that shield the light, the light-transmitting portions and the light-shielding portions being alternately arranged in the horizontal direction,
wherein each of the pixels includes a plurality of sub-pixels each including a light emitting region,
the sub-pixels in each of the pixels have sizes different from sizes obtained by equally dividing the pixel,
the light-transmitting portions are open in a diagonal direction with respect to the vertical direction, and
each of boundary lines between the light-transmitting portions and the light-shielding portions is determined (i) by moving parallel a continuous line that connects lines each of which connects gravity centers of adjacent sub-pixels or adjacent light emitting regions that are included in the sub-pixels or (ii) to be a continuous line that connects lines each of which connects midpoints of the gravity centers of the adjacent sub-pixels or the adjacent light emitting regions.

3. The image display panel according to claim 2,
wherein each of the boundary lines is determined by moving, parallel to the vertical direction, a continuous line that connects lines each of which connects gravity centers of sub-pixels or light emitting regions that are adjacent in the diagonal direction and are included in the sub-pixels.

4. The image display panel according to claim 3,
wherein the continuous line that connects the lines each of which connects the gravity centers of the sub-pixels or the light emitting regions that are adjacent in the diagonal direction and are included in the sub-pixels is bent to increase an amount of light from the sub-pixels that display the different images.

5. The image display panel according to claim 2,
wherein each of the boundary lines is a continuous line that connects lines each of which connects midpoints of gravity centers of sub-pixels or light emitting regions that are adjacent in the horizontal direction and are included in the sub-pixels.

6. The image display panel according to claim 5,
wherein the lines each of which connects the midpoints of the gravity centers of the sub-pixels or the light emitting regions that are adjacent in the horizontal direction are straight lines.

7. The image display panel according to claim 5,
wherein the lines each of which connects the midpoints of the gravity centers of the sub-pixels or the light emitting regions that are adjacent in the horizontal direction are bent to increase an amount of light from the sub-pixels that display the different images.

8. The image display panel according to claim 2,
wherein each of the pixels includes (i) a region of the sub-pixels and (ii) a region other than the region of the sub-pixels.

9. The image display panel according to claim 8,
wherein the region other than the region of the sub-pixels is a region for forming an auxiliary wiring.

10. The image display panel according to claim 2,
wherein the sub-pixels correspond to different colors, and
among the sub-pixels included in the pixel, a sub-pixel corresponding to one of the colors is different in size from a sub-pixel corresponding to an other one of the colors.

11. The image display panel according to claim 2,
wherein an area ratio of color components of sub-pixels viewed from one of the light-transmitting portions is approximately identical to an area ratio of color components of the sub-pixels included in the pixel.

12. The image display panel according to claim 2,
wherein the image separating unit is configured to change a shape of the light-transmitting portions.

13. The image display panel according to claim 2,
wherein the image separating unit is configured to transmit an entirety of the composite image by disabling the light-shielding portions.

14. The image display panel according to claim 2,
wherein the sub-pixels in the pixel correspond to different colors.

15. An image display device,
wherein the image display panel according to claim 2 allows a viewer to view one or both of a stereoscopic image and a two-dimensional (2D) image.
